(19) United States
(12) Patent Application Publication
(10) Pub. No.: US 2024/0241484 A1
(43) Pub. Date: Jul. 18, 2024

(54) METHODS AND APPARATUS TO AUTOMATE INVARIANT SYNTHESIS

(71) Applicants: Scott Douglas Constable, Portland, OR (US); Sebastian Szyller, Helsinki (FI); John Robert Matthews, Los Gatos, CA (US); Marcin Spoczynski, Hillsboro, OR (US)

(72) Inventors: Scott Douglas Constable, Portland, OR (US); Sebastian Szyller, Helsinki (FI); John Robert Matthews, Los Gatos, CA (US); Marcin Spoczynski, Hillsboro, OR (US)

(21) Appl. No.: 18/620,666

(22) Filed: Mar. 28, 2024

(51) Int. Cl. G05B 13/02

(52) U.S. Cl. CPC G05B 13/027

(57) ABSTRACT

Systems, apparatus, articles of manufacture, and methods are disclosed. An example apparatus to automate invariant synthesis includes: interface circuitry; instructions; and at least one programmable circuit to be programmed by the instructions to: produce a model input based on a program and/or contextual data corresponding to the program; provide the model input to a Large Language Model (LLM), the LLM to produce an invariant based on the model input; score the invariant; and incorporate the invariant into the program based on the score.

### BACKGROUND

In recent years, the complexity of electronic devices has increased. Devices such as light bulbs, watches, glasses, microwaves, speakers, etc., are now frequently designed with Internet access and/or other wireless communication abilities. Mobile phones are often expected to exhibit long battery life, communicate on 5G networks, introduce Artificial Intelligence features, etc., within roughly the same dimensions as the previous generation of mobile phones. To support such increased complexity, software, firmware, and hardware designs are thoroughly validated before being implemented into an electronic device.

### BRIEF DESCRIPTION OF THE DRAWINGS

FIG. 1 illustrating example of operations performed during hardware development.

FIG. 2 illustrating an example invariant.

FIG. 3 is a block diagram of an example implementation of the invariant generation system of FIG. 1.

FIG. 4 is a block diagram of an example implementation of the model trainer circuitry of FIG. 3.

FIG. 5 is a block diagram of an example implementation of the input production circuitry of FIG. 3.

FIG. 6 is a block diagram of an example implementation of the score determination circuitry of FIG. 3.

FIG. 7 is a flowchart representative of example machine-readable instructions and/or example operations that may be executed, instantiated, and/or performed by example programmable circuitry to implement the model trainer circuitry of FIG. 3.

FIG. 8 is a flowchart representative of example machine-readable instructions and/or example operations that may be executed, instantiated, and/or performed by example programmable circuitry to synthesize a candidate invariant as described in FIG. 3.

FIG. 9 is a flowchart representative of example machine-readable instructions and/or example operations that may be executed, instantiated, and/or performed by example programmable circuitry to score an invariant as described in FIG. 8.

FIG. 10 is a flowchart representative of example machine-readable instructions and/or example operations that may be executed, instantiated, and/or performed by example programmable circuitry to modify a model input as described in FIG. 7.

FIG. 11 is a block diagram of an example processing platform including programmable circuitry structured to execute, instantiate, and/or perform the example machine-readable instructions and/or perform the example operations of FIGS. 7-10 to implement the invariant generation circuitry 300 of FIG. 3.

FIG. 12 is a block diagram of an example implementation of the programmable circuitry of FIG. 11.

FIG. 13 is a block diagram of another example implementation of the programmable circuitry of FIG. 11.

FIG. 14 is a block diagram of an example software/firmware/instructions distribution platform (e.g., one or more servers) to distribute software, instructions, and/or firmware (e.g., corresponding to the example machine-readable instructions of FIGS. 7-10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

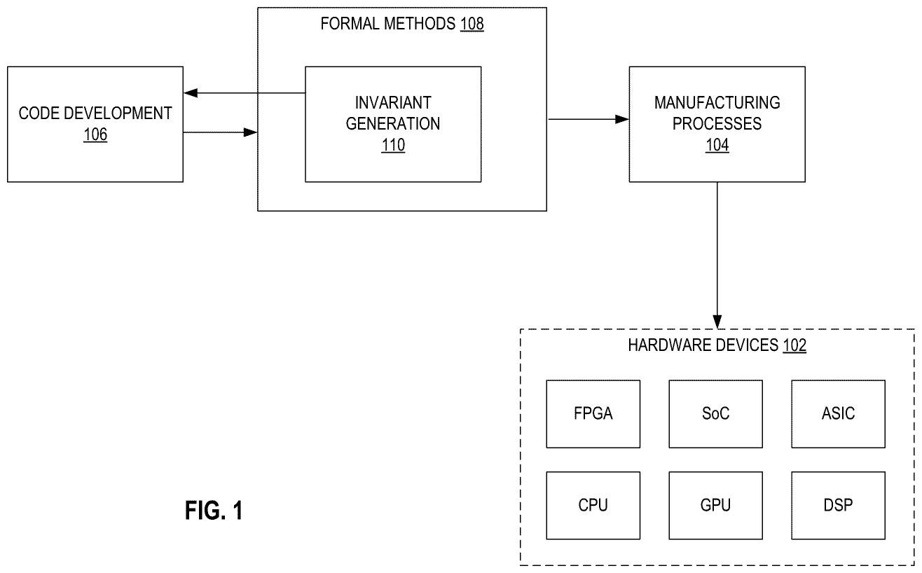

FIG. 1 illustrates example operations performed during hardware development. FIG. 1 includes hardware devices 102, manufacturing processes 104, code development 106, formal methods 108, and invariant generation 110.

The hardware devices 102 may be implemented by any type of device that includes programmable circuitry. Examples of a programmable circuit include but are not limited to a programmable microprocessor, a Field Programmable Gate Array (FPGA) that may instantiate instructions, a Central Processor Unit (CPU), a Graphics Processor Unit (GPU), a Digital Signal Processors (DSP), an XPU, or a microcontroller and integrated circuit such as an Application Specific Integrated Circuit (ASIC).

The manufacturing processes 104 refer to one or more operations to produce logic instructions and/or hardware logic as a physical device (e.g., one or more of the hardware devices 102). The manufacturing processes 104 may include but are not limited to integrated circuit fabrication. In the example of FIG. 1, code development 106 refers to the development of instructions and/or hardware logic which can go through manufacturing processes 104 and be used to program and/or become implemented by one or more of the hardware devices 102.

In general, manufacturing processes 104 can be both expensive and time consuming. As a result, industry members use formal methods 108 to validate the logic instructions and/or hardware logic (e.g., software and/or firmware) produced by code development 106 before manufacturing occurs. Formal methods 108 refers to the use of mathematical proofs to establish the soundness (e.g., correctness) of computer algorithms. For example, formal methods 108 can be used to verify that a depth-first graph traversal program written in C will always visit every node in a graph. In another example, formal methods 108 can also be used to verify that a register-transfer level (RTL) description of an arithmetic logic unit performs addition according to the processor's instruction set architecture specification.

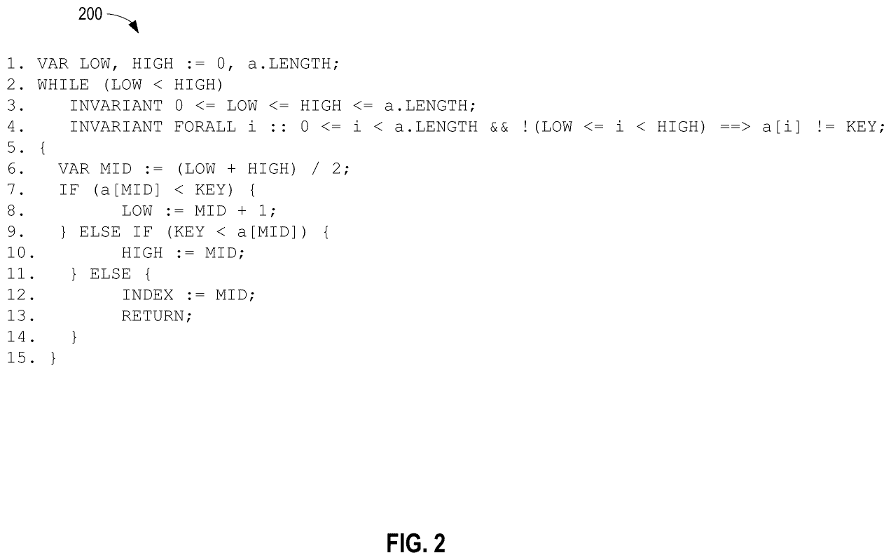

One aspect of using formal methods 108 to validate logic instructions and/or hardware logic is invariant generation 110. As used above and herein, an invariant refers to a logic assertion that a variable, property, or characteristic does not change within a program. For example, the loop in a depth-first traversal program may have the following invariant: “each iteration visits a valid (e.g., non-null) node in the graph.” In many examples, the validation of code using formal methods includes a) the production of one or more invariants, and b) the incorporation of the one or more invariants into the code being validated. An example of invariants within code is discussed further in connection with FIG. 2.

Invariant generation 110 may include different types of invariants based on the type of code being validated and circuitry being manufactured. Some types of assertions can be generated deterministically through techniques such as weakest-precondition generation. However, such verification tools that use an algorithmic approach are fundamentally limited by either the asymptotic complexity of traversing a search space, the undecidability of the expressive theories that are often required for formal verification, or both. Moreover, many types of invariants cannot be generated by software and must be written manually by a human (e.g., a verification engineer). As a result, industry members generally consider invariants difficult to synthesize and formal methods difficult to scale or automate.

Example methods, apparatus, and systems disclosed herein automate the synthesis of invariants in a manner that scales to a wide variety of software, firmware, and hardware in need of validation. Example input production circuitry adds contextual data to a variety of data sources to produce both training inputs and model inputs. Example model trainer circuitry uses the context rich model inputs to train a Large Language Model (LLM). Example model execution circuitry receives a proof framework and corresponding contextual data and uses the inputs to execute the LLM and generate a candidate invariant. Example score determination circuitry generates a score for the candidate invariant based on one or more weighted subscores. If the score satisfies (e.g., exceeds) a threshold value, counterexample circuitry checks for counterexamples to the candidate invariant. If the score does not satisfy (e.g., is lower than) a threshold value, or if a counterexample is found, the candidate invariant is discarded, and example input modification circuitry changes the model input and/or the training input described above. If the score satisfies (e.g., exceeds) the threshold and the check fails to find a counterexample, proof test circuitry checks if the candidate invariant can discharge the proof obligation introduced by the proof framework. If the candidate invariant satisfies one or more sub-goals needed to discharge the proof obligation, the invariant is usable and can be incorporated into the logic instructions and/or hardware logic corresponding to the proof framework.

FIG. 2 illustrates an example invariant. FIG. 2 shows an example code snippet 200.

The code snippet 200 is an example of code written in Dafny®. Dafny® is a programming language commonly used to support verification of code through formal methods. For example, developers may write code in a first programming language (e.g., C) based on the needs of their particular use case and then use a tool to convert the code into Dafny® so that invariants can be added.

The code snippet 200 includes two examples of invariants at lines 3 and 4. The first invariant, at line 3, constrains the variables ‘low’ and ‘high’ to be valid indexes within the array ‘a’. The second invariant, at lines 4-5, specifies that variables ‘low’ and ‘high’ will eventually converge to the index of ‘key’ (if ‘key’ is present in the array ‘a’). Because invariants are always true, verification of the code snippet 200 can include testing the firmware, the hardware, and/or the software surrounding the code snippet 200 to look for any use case where either invariant becomes false. If a use case is found in which either invariant becomes false, the logic instructions and/or hardware logic may have an error. Additionally or alternatively, a use case of the invariant becoming false indicates that the invariant itself was written incorrectly.

In the code snippet 200, the invariants of lines 3-4 support the verification of the ‘while’ condition that causes lines 5-15 to be repeatedly executed so long as line 2 remains true. The invariants also support the verification of the if, else if, and else statements of lines 7-14 that cause one of three operations to occur based on the values of ‘key’ and ‘a[mid]’.

Existing techniques to automatically produce invariants are generally better at producing invariants for some types of code than others. Such existing techniques generally cannot produce invariants for portions of code that include conditions (e.g., ‘when’ statements, ‘if’ statements, loops, etc.). Advantageously, teachings disclosed herein automatically synthesize invariants that support conditions. Therefore, example systems implemented using teachings disclosed herein could receive lines 1, 2, 5-15 of FIG. 2 as an input and automatically produce the code snippet 200 (which includes the invariants in lines 3-4). In contrast, legacy systems that receive the same input may need to notify a human to manually write the invariants of FIG. 2. Furthermore, example systems disclosed herein can leverage LLMs to generate and test candidate invariants at a rate that scares approximately linearly with the size of the input model. In contrast, legacy techniques to automatically produce invariants generally scale exponentially with respect to the size of the input model. Accordingly, examples disclosed herein generate invariants in a manner that is more scalable and more efficient than legacy techniques.

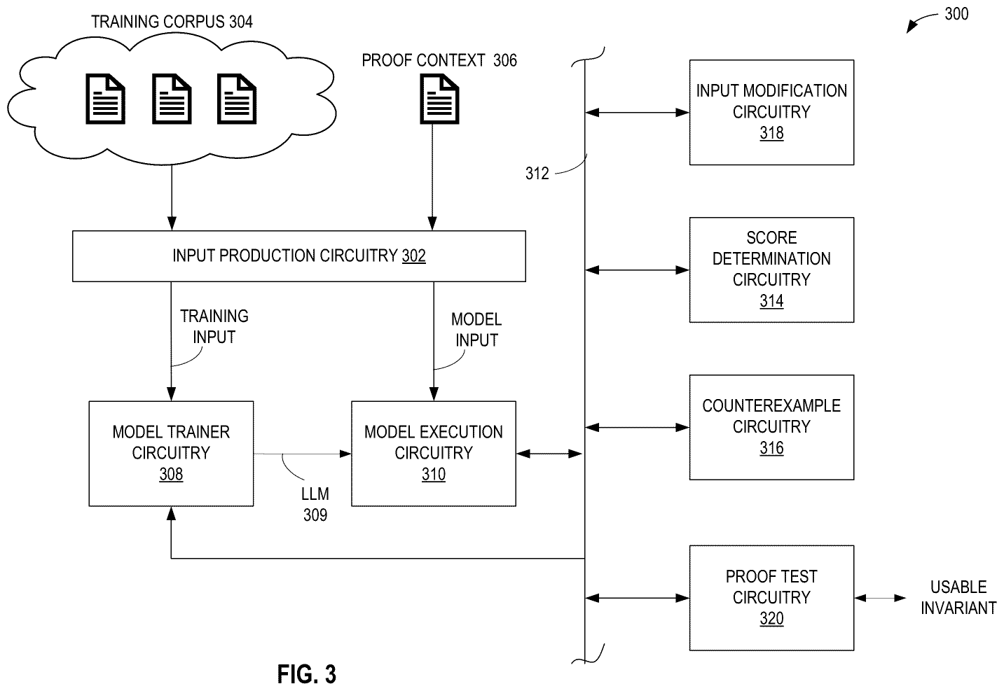

FIG. 3 is a block diagram of an example invariant generation circuitry 300. The invariant generation circuitry 300 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the invariant generation circuitry 300 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers. The invariant generation circuitry 300 of FIG. 3 includes example input production circuitry 302, an example training corpus 304, an example proof context 306, example model trainer circuitry 308, an example Large Language Model (LLM) 309, example model execution circuitry 310, an example bus 312, example score determination circuitry 314, example counterexample circuitry 316, example input modification circuitry 318, and example proof test circuitry 320.

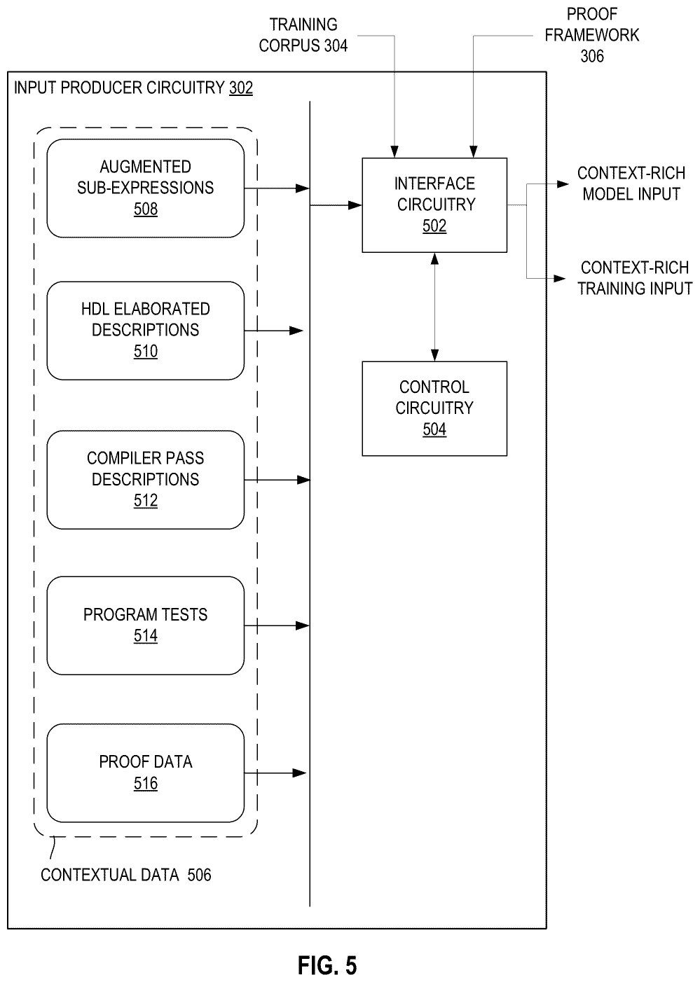

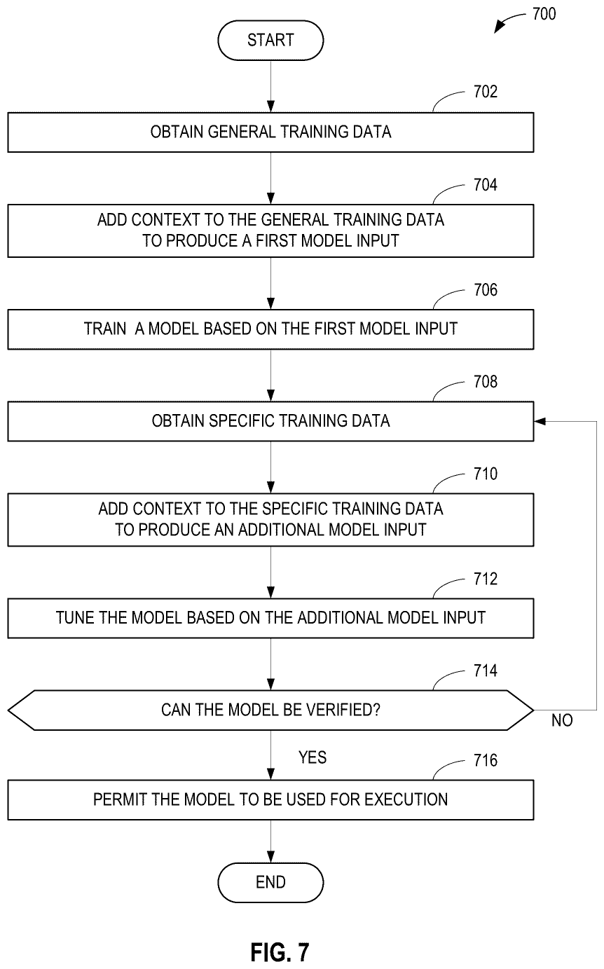

The example input production circuitry 302 increases the quality of model inputs by adding contextual data. In the example of FIG. 3, the input production circuitry 302 adds contextual data to materials from the training corpus 304 to produce a training input for the model trainer circuitry 308. The example input production circuitry 302 also adds contextual data to the proof context 306 to produce a model input for the model execution circuitry 310. The type and quantity of contextual data provided by the input production circuitry 302 may depend on any number of factors. Such factors include but are not limited to the type(s) of data provided within the training corpus 304 and/or the proof context 306, the type(s) of invariants to be synthesized, computational resource limits, etc. The input production circuitry 302 is discussed in connection with FIG. 5. In some examples, the input production circuitry 302 is instantiated by programmable circuitry executing input production instructions and/or configured to perform operations such as those represented by the flowchart(s) of FIGS. 7-10.

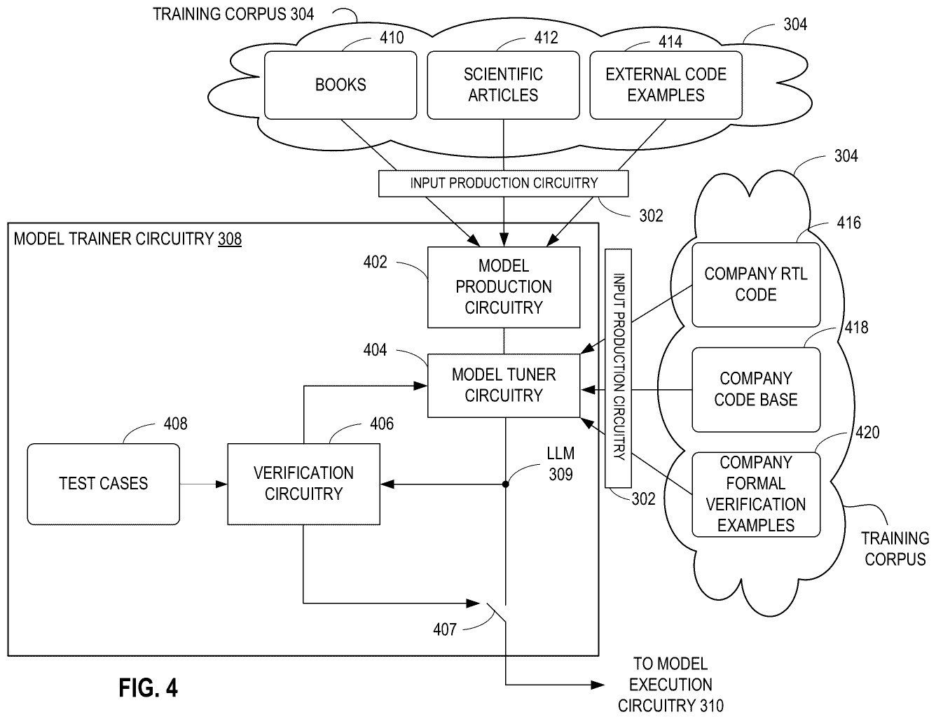

The example training corpus 304 refers to any kind of file(s), document(s), and/or data source(s) that may be used to train the LLM 309. The training corpus 304 may include, but is not limited to, explanation(s) explaining the significance and use of formal method(s), proof framework(s), and invariant(s), example(s) of proof framework(s), example(s) of valid invariant(s), example(s) of invalid invariant(s) and their counterexample(s), etc. The example training corpus 304 may include data from any number of sources, including sources available to the general public and sources provided by private entities. The example training corpus 304 is discussed below in connection with FIG. 4.

The example proof context 306 refers to any logic instructions and/or hardware logic in need of formal methods 108 to prove the logic is correct (e.g., will behave expectedly) and can proceed onto the manufacturing processes 104. In some examples, the logic instructions and/or hardware logic that composes a proof framework may be referred to as machine-readable instructions, source code, software, firmware, etc.

The proof context 306 also has a corresponding proof obligation. As used herein, the term “proof obligation” refers to a goal that must be met to prove and/or verify the sustainability of the proof framework (e.g., before the logic instructions and/or hardware logic is verified and ready for manufacturing). In many examples, a proof obligation may be broken into sub-goals. For example, verifying the correctness of a specific programming file (e.g., the proof obligation) may include verifying the correctness of all functions called on by the file, then verifying the logic within the file that connects the function calls (e.g., sub-goals). In some examples, successfully meeting the main goal of a proof obligation is referred to as “discharging the proof obligation”.

Whereas successfully discharging the proof obligation indicates the proof context 306 is fully verified in examples described herein, in other examples, a proof obligation refers only to the set of proofs needed to complete invariant generation. In these other examples, once the proof obligation is discharged, there may still be other formal method operations that should be completed (either manually or through an automatic process) before the proof context 306 is considered verified and can proceed to manufacturing processes 104.

The example model trainer circuitry 308 of FIG. 3 uses the contextually rich training data from the training corpus 304 and from the input production circuitry 302 to train the LLM 309. In general, an LLM refers to a large language model. A LLM may be implemented by a machine learning model that uses deep learning algorithms to perform natural language processing (NLP) tasks. Some LLMs available to the public are trained to perform NLP to support a wide variety of everyday tasks (e.g., aggregating information from various online sources to answer a question, telling jokes, summarizing articles, etc.). ChatGPT is a known example of such an LLM. Other LLMs are trained to support a wide variety of code development tasks (e.g., generating code, labelling code, responding to code-based prompts using NLP, etc.) Code Llama, OpenAI Codex™, and Github Copilot™ are known examples of such LLMs.

In examples described herein, the model trainer circuitry 308 trains the LLM 309 with the specific goal of using NLP to produce an invariant that can be incorporated into the proof context 306. The model trainer circuitry 308 performs model tuning and model verification operations to produce the LLM 309 having such specific capabilities. An example implementation of the model trainer circuitry 308 is discussed below in connection with FIG. 4. In some examples, the model trainer circuitry 308 is instantiated by programmable circuitry executing model trainer instructions and/or configured to perform operations such as those represented by the flowchart(s) of FIGS. 7-10.

The example model execution circuitry 310 uses the contextually rich model input from the proof context 306 and from the input production circuitry 302 to execute the LLM 309 and output text. In examples described herein, the output text of the LLM 309 is referred to as a “candidate invariant”. Before the candidate invariant can be categorized as useful and incorporated into the proof context 306, other components within the invariant generation circuitry 300 analyze and test the invariant as described further below. In some examples, the model execution circuitry 310 is instantiated by programmable circuitry executing model execution instructions and/or configured to perform operations such as those represented by the flowchart(s) of FIGS. 7-10.

The example bus 312 refers to one or more wired and/or wireless connections that enables communication between the model execution circuitry 310, the score determination circuitry 314, the counterexample circuitry 316, the input modification circuitry 318, and the proof test circuitry 320. The example bus 312 may be implemented using one or more communication systems that meet pre-determined threshold power and latency requirements. For example, the bus 312 may include inter-device communication protocols (such as Application Programming Interfaces (APIs), etc.) and/or intra-device communication protocols (such as Open Core Protocol (OCP), Advanced Extensible Interface (AXI), etc.).

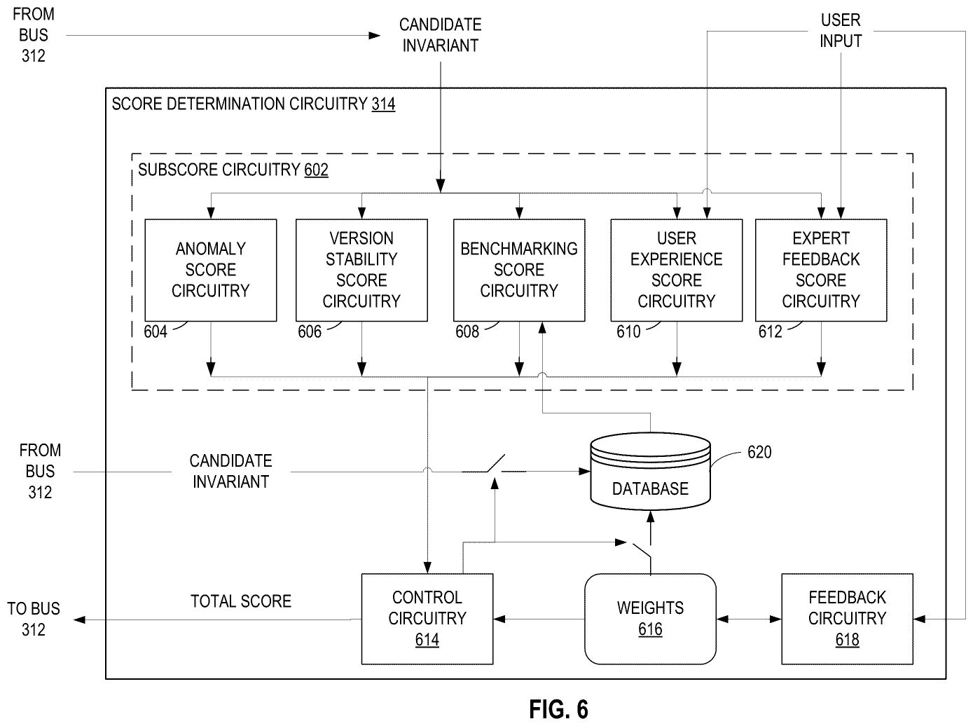

The example score determination circuitry 314 scores the candidate invariant. In some examples, the score determination circuitry 314 produces a total score for the model execution circuitry 310 by calculating a weighted sum of multiple subscores. The values of the weights, the number of subscores, and the type(s) of subscores may depend on any number of factors. Such factors include but are not limited to the type(s) of data provided within the proof context 306, the type(s) of the candidate invariant, computational resource limits, etc. An example implementation of the score determination circuitry 314 is discussed below in connection with FIG. 6. In some examples, the score determination circuitry 314 is instantiated by programmable circuitry executing score determination instructions and/or configured to perform operations such as those represented by the flowchart(s) of FIGS. 7-10.

The counterexample circuitry 316 checks for counterexamples to the candidate invariant. As used above and herein, a “counterexample” refers to any data that shows the assertion posited by the candidate invariant is not always correct (thus making the candidate invariant invalid and not usable in the proof context 306). The counterexample circuitry 316 may use any suitable technique(s) to check for counterexamples. Such technique(s) include but are not limited to symbolic algorithm(s), bounded model-checking, abstraction, Counterexample-guided abstraction refinement (CEGAR), Satisfiability modulo theories (SMT) solver programs, Boolean satisfiability (B-SAT) solver programs, etc. In some examples, the counterexample circuitry 316 is instantiated by programmable circuitry executing counterexample instructions and/or configured to perform operations such as those represented by the flowchart(s) of FIGS. 7-10.

The example input modification circuitry 318 modifies the model input and/or the training input described above. After modifying the model input, the input modification circuitry 318 also prompts the model execution circuitry 310 to generate a new candidate invariant. Similarly, after modifying the training input, the input modification circuitry 318 prompts the model trainer circuitry 308 to train a new version of the LLM 309. The input modification circuitry 318 may perform such operations in response to a determination that a previous candidate invariant is not usable (e.g., does not have a sufficient score (e.g., a sufficiently high score), has a counterexample, etc.). In some examples, model input modification may also be referred to as changing, enhancing, or perturbing the input.

The amount and type(s) of modification(s) that occurs to the model input and/or training input may depend on any number of factors. Such factors include but are not limited to the type(s) of data provided within the proof context 306, the type(s) of the candidate invariant, computational resource limit(s), etc. In some examples, the input modification circuitry 318 is instantiated by programmable circuitry executing input modification instructions and/or configured to perform operations such as those represented by the flowchart(s) of FIGS. 7-10.

The proof test circuitry 320 determines whether the candidate invariant discharges the proof obligation of the proof context 306. The proof test circuitry 320 may determine whether the candidate invariant discharges the proof obligation by analyzing the proof obligation as a set of subgoals within a tree data structure. That is, a series of proof subgoals may relate to one another in a hierarchical fashion such that, if all subgoals represented as leaf nodes are proven, then the root node is also proven, and the proof obligation can be discharged. A candidate invariant that successfully proves a subgoal of the proof obligation is considered a usable invariant that can be incorporated into the proof context 306.

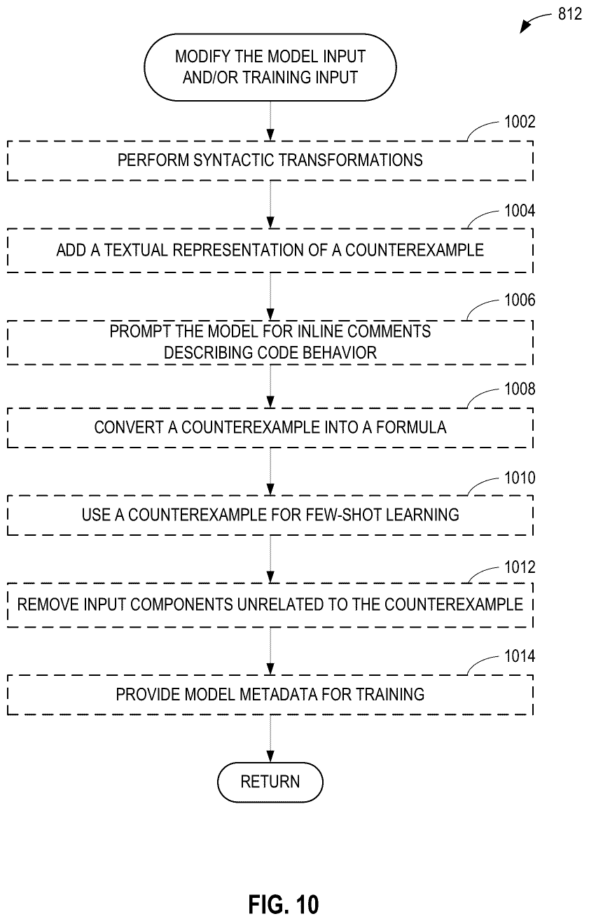

The example proof test circuitry 320 may use a satisfiability solver program to perform one or more operations related to completing a proof sub-goal and/or discharging a proof obligation. Example implementations of satisfiability solver programs are discussed below in connection with FIG. 10. In some examples, the proof test circuitry 320 is instantiated by programmable circuitry executing proof test instructions and/or configured to perform operations such as those represented by the flowchart(s) of FIGS. 7-10.

The example invariant generation circuitry 300 of FIG. 3 is an example implementation of the invariant generation 110 that uses counterexample-guided inductive synthesis (CEGIS). While other techniques to generate invariants use a form of CEGIS, such techniques cannot synthesize invariants when the verification involves undecidable theory. Undecidable theory refers to a branch of computer science that seeks to determine whether it is possible, for a given question, to construct an algorithm that always leads to a correct yes-or-no answer. A known version of such an undecidable problem is the halting problem, where it is proven that there is no algorithm that correctly determines whether an arbitrary program eventually halts when run. As a result of such complexities in undecidable theory, other CEGIS techniques can struggle to generate an invariant for a conditional statement in code (e.g., a ‘when’ statement, an ‘if’ statement, a loop, etc.).

In contrast to other CEGIS techniques that use logical representations of code as model inputs, example invariant generation circuitry 300 disclosed herein generate candidate invariants using textual representations of code as model inputs. Example model inputs may include text based on sources that specifically discuss and show invariants, and contextual data that corresponds to said sources. As a result, example model execution circuitry 310 of FIG. 3 can use the LLM 309 to generate a wide variety of invariants, including conditions. Furthermore, if the example score determination circuitry 314 of FIG. 3 produces a score for a candidate invariant that does not exceed a threshold, the candidate invariant is discarded before additional compute resources are spent checking for a counterexample. Such operations take less time and consume less power than techniques that check each candidate invariant for counterexamples. Example connections between components of the example invariant generation circuitry 300 are discussed below in connection with FIGS. 7-10.

In some examples, the code within the proof context 306 is a software application that continues to develop over time (e.g., for bug fixes, additional functionality, etc.). In such examples, the invariant generation circuitry 300 may be used to periodically reassess the usability of invariants within the proof context 306. Furthermore, if changes to the proof context 306 make the existing invariants less useful than they previously were, example invariant generation circuitry 300 may be used to synthesize new invariants that are more useful within the updated code than the previous invariants. An existing invariant may be considered less useful if it is scored lower by the score determination circuitry 314 than it previously was, if a counterexample is now found when none were previously identified, if the existing invariant now fails to prove a sub-goal that was previously solved, etc.

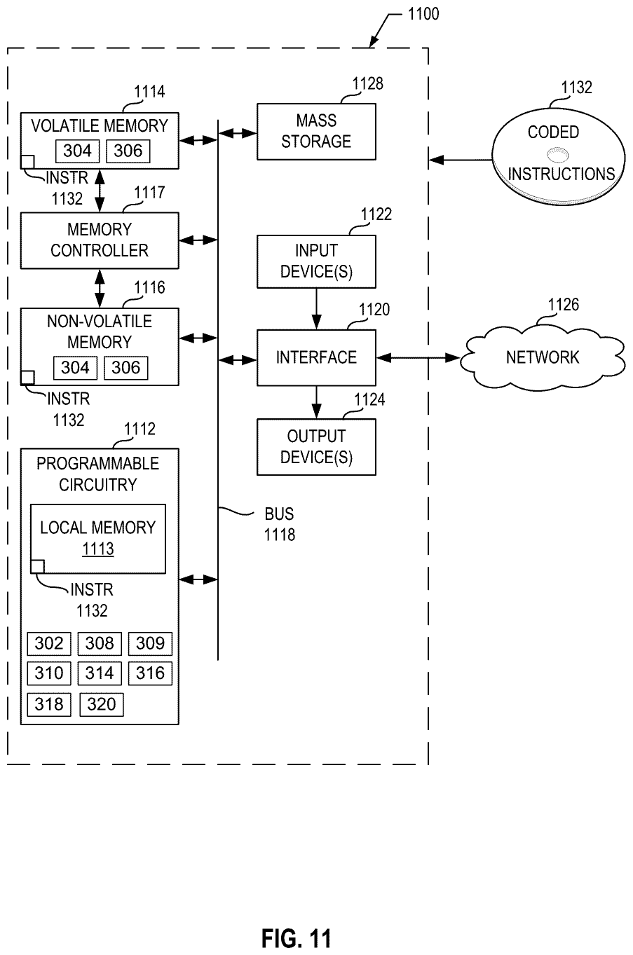

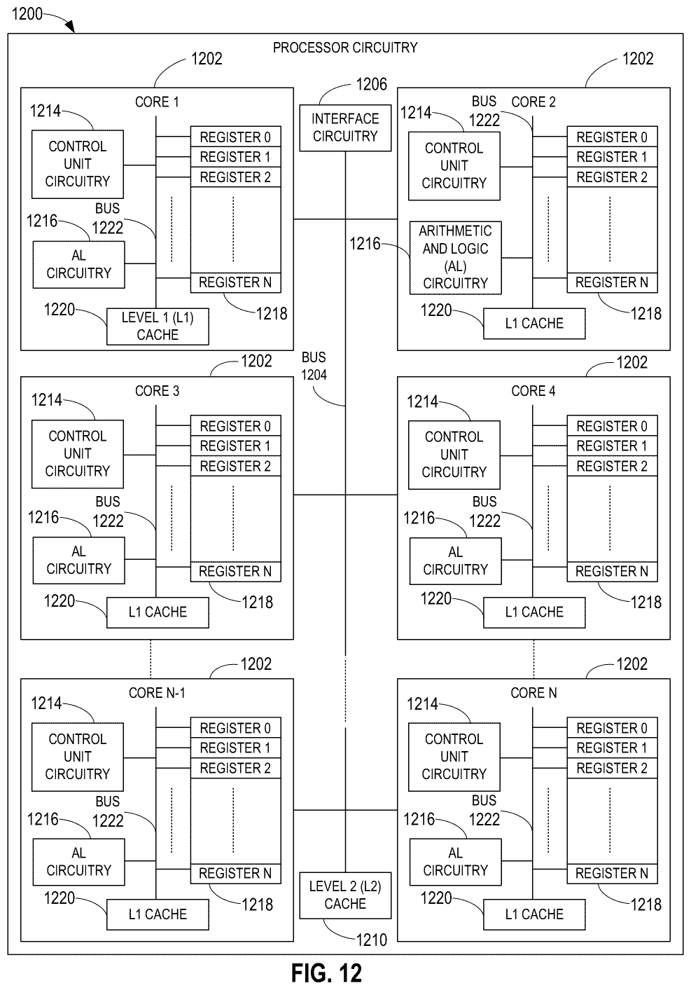

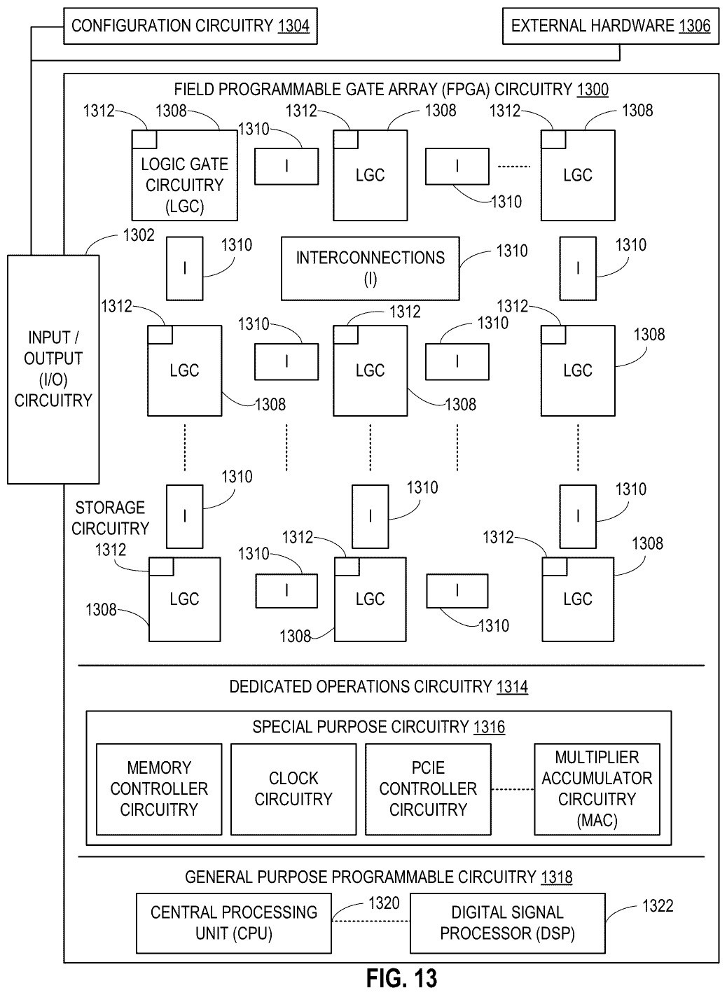

In some examples, the invariant generation circuitry 300 includes means for adding contextual data. For example, the means for adding contextual data may be implemented by input production circuitry 302. In some examples, the input production circuitry 302 may be instantiated by programmable circuitry such as the example programmable circuitry 1112 of FIG. 11. For instance, the input production circuitry 302 may be instantiated by the example microprocessor 1200 of FIG. 12 executing machine executable instructions such as those implemented by at least blocks 704, 710 of FIG. 7. In some examples, the input production circuitry 302 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the input production circuitry 302 may be instantiated by any other combination of hardware, software, and/or firmware. For example, the input production circuitry 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the invariant generation circuitry 300 includes means for training a model. For example, the means for training may be implemented by model trainer circuitry 308. In some examples, the model trainer circuitry 308 may be instantiated by programmable circuitry such as the example programmable circuitry 1112 of FIG. 11. For instance, the model trainer circuitry 308 may be instantiated by the example microprocessor 1200 of FIG. 12 executing machine executable instructions such as those implemented by at least blocks 706, 712-716 of FIG. 7. In some examples, the model trainer circuitry 308 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the model trainer circuitry 308 may be instantiated by any other combination of hardware, software, and/or firmware. For example, the model trainer circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

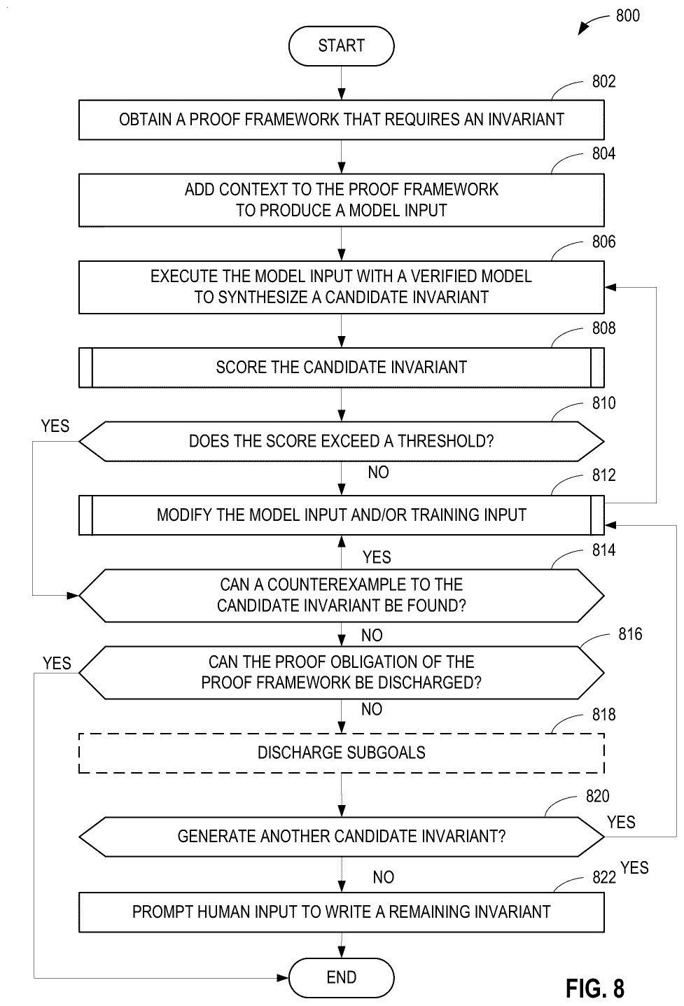

In some examples, the invariant generation circuitry 300 includes means for executing a model. For example, the means for executing may be implemented by model execution circuitry 310. In some examples, the model execution circuitry 310 may be instantiated by programmable circuitry such as the example programmable circuitry 1112 of FIG. 11. For instance, the model execution circuitry 310 may be instantiated by the example microprocessor 1200 of FIG. 12 executing machine executable instructions such as those implemented by at least blocks 806 of FIG. 8. In some examples, the model execution circuitry 310 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the model execution circuitry 310 may be instantiated by any other combination of hardware, software, and/or firmware. For example, the model execution circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

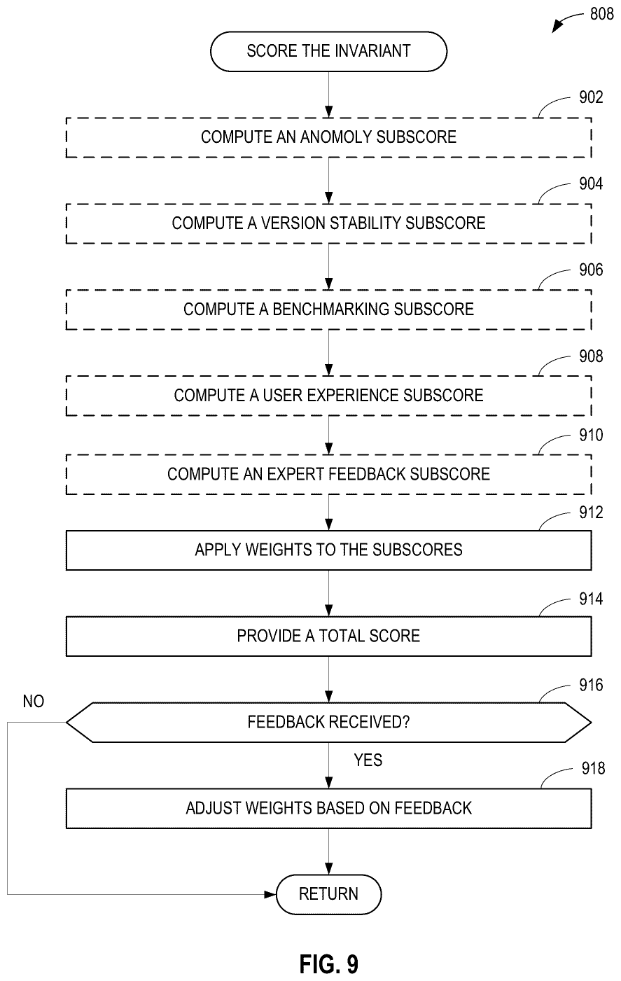

In some examples, the invariant generation circuitry 300 includes means for scoring an invariant. For example, the means for scoring may be implemented by score determination circuitry 314. In some examples, the score determination circuitry 314 may be instantiated by programmable circuitry such as the example programmable circuitry 1112 of FIG. 11. For instance, the score determination circuitry 314 may be instantiated by the example microprocessor 1200 of FIG. 12 executing machine executable instructions such as those implemented by at least blocks 808, 902-918 of FIGS. 8 and 9. In some examples, the score determination circuitry 314 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the score determination circuitry 314 may be instantiated by any other combination of hardware, software, and/or firmware. For example, the score determination circuitry 314 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the invariant generation circuitry 300 includes means for identifying counterexamples to an invariant. For example, the means for identifying may be implemented by counterexample circuitry 316. In some examples, the counterexample circuitry 316 may be instantiated by programmable circuitry such as the example programmable circuitry 1112 of FIG. 11. For instance, the counterexample circuitry 316 may be instantiated by the example microprocessor 1200 of FIG. 12 executing machine executable instructions such as those implemented by at least blocks 814 of FIG. 8. In some examples, the counterexample circuitry 316 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the counterexample circuitry 316 may be instantiated by any other combination of hardware, software, and/or firmware. For example, the counterexample circuitry 316 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the invariant generation circuitry 300 includes means for modifying a model input and/or a training input. For example, the means for modifying may be implemented by input modification circuitry 318. In some examples, the input modification circuitry 318 may be instantiated by programmable circuitry such as the example programmable circuitry 1112 of FIG. 11. For instance, the input modification circuitry 318 may be instantiated by the example microprocessor 1200 of FIG. 12 executing machine executable instructions such as those implemented by at least blocks 812, 1002-1014 of FIGS. 8 and 10. In some examples, the input modification circuitry 318 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the input modification circuitry 318 may be instantiated by any other combination of hardware, software, and/or firmware. For example, the input modification circuitry 318 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the invariant generation circuitry 300 includes means for checking a prof obligation. For example, the means for checking may be implemented by proof test circuitry 320. In some examples, the proof test circuitry 320 may be instantiated by programmable circuitry such as the example programmable circuitry 1112 of FIG. 11. For instance, the proof test circuitry 320 may be instantiated by the example microprocessor 1200 of FIG. 12 executing machine executable instructions such as those implemented by at least blocks 816-822 of FIG. 8. In some examples, the proof test circuitry 320 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the proof test circuitry 320 may be instantiated by any other combination of hardware, software, and/or firmware. For example, the proof test circuitry 320 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

FIG. 4 is a block diagram of an example implementation of the model trainer circuitry of FIG. 3. FIG. 4 includes the training corpus 304, the input production circuitry 302, and the model trainer circuitry 308. The model trainer circuitry 308 includes example model production circuitry 402, example model tuner circuitry 404, example verification circuitry 406, an example switch 407, and example test cases 408. The example training corpus 304 includes example books 410, example scientific articles 412, external code examples 414, example company register-transfer level (RTL) code 416, an example company code base 418, and company formal verification examples 420.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, a LLM is used. Using an LLM enables the use of NLP to generate candidate invariants as described above. In general, machine learning models/architectures that are suitable to use in the example approaches disclosed herein are deep learning neural networks. Examples of deep learning include but are not limited to Convolutional Neural Networks (CNNs), Generative Adversarial Networks (GANs), Deep Belief Networks (DBNs), Recurrent Neural Networks (RNNs), etc.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples described herein, the model trainer circuitry 308 engages in both supervised training and unsupervised training. For example, the model production circuitry 402 produces an initial LLM based on vast and diverse sources of data available to the general public. Examples of such general training data include but are not limited to the books 410, scientific articles 412, and external code examples 414 shown in the training corpus 304. The model production circuitry 402 also produces the initial LLM based on corresponding contextual data provided by the input production circuitry 302. The model production circuitry 402 endows the initial LLM with a broad understanding of various subjects, enabling the LLM to grasp context, apply logic, and understand a multitude of programming and hardware description languages. Such training may be referred to as unsupervised because it does not necessarily include examples of invariants that are labelled valid or invalid. In some examples, the model production circuitry 402 is instantiated by programmable circuitry executing model production instructions and/or configured to perform operations such as those represented by the flowchart(s) of FIGS. 7-10.

The example model tuner circuitry 404 trains the initial LLM further using specific training data. Such specific training data includes but is not limited to RTL code 416 that has been collected over time from a company, articles detailing “how-to” approaches specific to the company's practices, portions of the company's code base 418, and formal verification examples 420 performed on the company's code (and corresponding contextual data provided by the input production circuitry 302). The example model tuner circuitry 404 tailors the LLM's expertise, adapting it to the particular requirements of a company's domain. Accordingly, the model trainer circuitry 308 undergoes supervised training with specific examples (including labelled examples of correct and incorrect invariants) that improve the LLM's ability to respond to a proof context 306 submitted by the company. After the subsequent training by the model tuner circuitry 404, the initial LLM transforms into the LLM 309 (e.g., an LLM specifically trained to synthesize invariants for use within a proof context 306). In some examples, the subsequent training performed by the model tuner circuitry 404 is referred to as model tuning. In some examples, the model tuner circuitry 404 is instantiated by programmable circuitry executing model tuner instructions and/or configured to perform operations such as those represented by the flowchart(s) of FIGS. 7-10.

In examples described herein, the entity that submits the proof context 306 in need of invariants (e.g., a company) also provides specific training data used by the model tuner circuitry 404 to enhance the performance of the initial LLM. In other examples, the entity that submits the proof context 306 does not provide specific training data. In such other examples, the model tuner circuitry 404 may still enhance the performance of the initial LLM by training on data that provides labelled examples of invariants and formal verification algorithms (and corresponding contextual data provided by the input production circuitry 302). The training in such other examples may describe invariants and formal verification generically. In contrast, the example of FIG. 4 shows that the model tuner circuitry 404 trains the LLM with company-specific examples of invariants and formal verification.

The example verification circuitry 406 determines whether the LLM 309 produced by the model tuner circuitry 404 is ready to be provided to the model execution circuitry 310. In the example of FIG. 4, the verification circuitry 406 keeps the switch 407 open when the LLM 309 is not yet ready to be provided to the model execution circuitry 310. Similarly, the verification circuitry 406 closes the switch 407 when the LLM 309 is ready to be provided to the model execution circuitry 310. In other examples, the verification circuitry 406 uses a different technique to prevent and/or allow the LLM 309 to be provided to the model execution circuitry 310. In some examples, the verification circuitry 406 is instantiated by programmable circuitry executing verification instructions and/or configured to perform operations such as those represented by the flowchart(s) of FIGS. 7-10.

The example verification circuitry 406 runs the LLM 309 through the test cases 408. Execution of a test case may include, but is not limited to, providing various sample inputs to the LLM 309 to obtain model outputs. The results of the test cases 408 (e.g., the model outputs) indicate whether the LLM 309 is accurate, relevant, and/or in compliance with formal verification standards (e.g., ready to be provided to the model execution circuitry 310). In some examples, the test cases 408 are written or augmented by humans with expertise in formal verification techniques. Similarly, the example verification circuitry 406 may determine relevancy of the LLM 309 using human feedback and/or ranked preferences. Such relevancy data encourages the LLM 309 to generate text that aligns with human values (e.g. ethics, helpfulness, etc.).

The example verification circuitry 406 may consider the LLM 309 verified once the model output exceeds one or more threshold scores corresponding to accuracy, relevancy, and compliance with formal verification standards. If the example verification circuitry 406 determines the LLM 309 is not verified, it instructs the model tuner circuitry 404 to perform additional training and produce an updated version of the LLM 309. Such additional training may include but is not limited to obtaining additional data from the training corpus 304, performing training operations for a greater number of iterations and/or clock cycles, etc. Once the verification circuitry 406 determines the LLM 309 is verified, it allows the LLM 309 to be provided to the model execution circuitry 310 (as shown in the example of FIG. 4 by closing the switch 407).

FIG. 5 is a block diagram of an example implementation of the input production circuitry of FIG. 3. The input production circuitry 302 includes example interface circuitry 502, example control circuitry 504, and example contextual data 506. In the example of FIG. 5, the contextual data 506 include example augmented sub-expressions 508, example hardware description language (HDL) elaborated descriptions 510, example compiler pass descriptions 512, example program tests 514, and example proof data 516.

The example interface circuitry 502 enables the control circuitry 504 to communicate with external devices. For example, the interface circuitry 502 receives training materials from the training corpus 304 or the proof context 306 and provides the corresponding data to the control circuitry 504. As another example, the interface circuitry 502 passes the inputs to the appropriate destination (e.g., the training materials are passed to the model trainer circuitry 308 and the proof context 306 is passed to the model execution circuitry 310). The interface circuitry 502 also passes one or more of the contextual data 506 to the appropriate destination based on instructions from the control circuitry 504. The one or more entries from the contextual data 506 and the original input to the interface circuitry 502 are collectively referred to as a context rich input.

The interface circuitry 502 may include a communication fabric, transceivers, antennas, and/or other components required to send and receive such information for the control circuitry 504. In some examples, the interface circuitry 502 is instantiated by programmable circuitry executing interface instructions and/or configured to perform operations such as those represented by the flowchart(s) of FIGS. 7-10.

The example control circuitry 504 determines which of the contextual data 506 are used to form a context rich input. A given entry from the contextual data 506 may be applicable to some but not all of the possible inputs received by the interface circuitry 502. Accordingly, the example control circuitry 504 selects the one or more items from the contextual data 506 based on the type of input provided by the interface circuitry 502. In some examples, the control circuitry 504 is instantiated by programmable circuitry executing control instructions and/or configured to perform operations such as those represented by the flowchart(s) of FIGS. 7-10. The control circuitry 504 may be implemented with any type of programmable circuitry.

In some examples, the control circuitry 504 generates and provides augmented sub-expressions 508 as part of the context rich input. To perform the augmentation, the control circuitry 504 adds parentheses and/or annotations to an amount of code. For example, the interface circuitry 502 may receive the following line of code:

$$var mid := ( low + high ) / 2 ;$$

The control circuitry 504 may then modify the line of code to generate the following augmented sub-expression 508:

$$var ( mid : int32 ) := ( ( ( low : int32 ) + ( high : i nt32 ) ) / ( 2:i nt32 ) ) ;$$

The additional context provided by augmented sub-expression 508 may increase the likelihood of the LLM 309 generating type-correct invariants that use the correct operator precedence.

In some examples, the control circuitry 504 generates and adds HDL elaborated descriptions 510 as part of the context rich input. For example, some inputs received by the interface circuitry 502 may be code written in an HDL. The compilation of such code generally includes an elaboration phase where parameterized modules are instantiated with concrete parameter values and then type-checked. Accordingly, when given pre-elaborated HDL code as an input, the example control circuitry 504 may generate a post-elaborated version of the HDL code. In such examples, the example control circuitry 504 then instructs the interface circuitry 502 to include both the pre-elaborated version and the post-elaborated version of the HDL code as part of the context rich input. The pre-elaborated and post-elaborated versions may be collectively referred to as HDL elaborated descriptions 510 as described above and herein.

Like the HDL elaborated descriptions 510, programs containing macros and/or templates can also be represented in pre-expansion and post-expansion versions. In response to receiving such a program as an input, the example control circuitry 504 provides both the pre-expanded and post-expanded versions of said constructs in the context rich input. Providing two versions of code inputs may improve accuracy of the LLM 309.

In some examples, the control circuitry 504 generates and adds compiler pass descriptions 512 as part of the context rich input. Some compiler frameworks can generate a parse tree or a textual description of how a program is transformed after each compiler pass. Such frameworks include but are not limited to the LLVM compiler infrastructure. When the interface circuitry 502 receives code at its input that is capable of being compiled in such a framework, the control circuitry 504 does so and provides the resulting parse trees and/or textual descriptions as part of the context rich input.

In some examples, the control circuitry 504 locates and provides program tests 514 as part of the context rich input. For example, many software and hardware programs have corresponding unit test harnesses and regression test suites. If such a program is received by the interface circuitry 502 at its input, the control circuitry 504 may locate the relevant unit tests and/or regression test suites and provide said program tests 514 as part of the context rich input. In some examples, the control circuitry 504 additionally: a) runs the identified tests on the input program to generate a trace output, and b) provides the trace output as part of the context rich input.

In some examples, the control circuitry 504 locates and provides proof data 516 as part of the context rich input. For example, some programs have an explicit proof or a proof script for respective invariants within the program. If such a program is received by the interface circuitry 502 at its input, the control circuitry 504 may locate the relevant explicit proofs and/or proof scripts and provide the proof data 516 as part of the context rich input.

FIG. 6 is a block diagram of an example implementation of the score determination circuitry 314 of FIG. 3. In the example of FIG. 6, the score determination circuitry 314 includes example subscore circuitry 602, example control circuitry 614, example weights 616, example feedback circuitry 618, and an example database 620. The example subscore circuitry 602 includes example anomaly score circuitry 604, example version stability score circuitry 606, example benchmarking score circuitry 608, example user experience score circuitry 610, and example expert feedback score circuitry 612.

The example subscore circuitry 602 receives the candidate invariant produced by the model execution circuitry 310 via the bus 312. The subscore circuitry 602 then generates one or more subscores that can be used by the control circuitry 614 to generate a total score. The example subscore circuitry 602 may generate a first group of subscores for a first candidate invariant and generate a second group of subscores for a second candidate invariant. The example subscore circuitry 602 may choose which subscores to generate based on any number of factors including but not limited to the type of candidate invariant, data within the proof context 306, etc. The example subscore circuitry 602 generates the subscores chosen for a given candidate invariant in parallel. That is, one or more of the version stability score circuitry 606, the benchmarking score circuitry 608, the user experience score circuitry 610, and the expert feedback score circuitry 612 generate respective subscores concurrently with one another. In some examples, the subscore circuitry 602 is instantiated by programmable circuitry executing subscore instructions and/or configured to perform operations such as those represented by the flowchart(s) of FIGS. 7-10. The control circuitry 504 may be implemented with any type of programmable circuitry.

The anomaly score circuitry 604 generates a subscore based on a number of detected anomalies corresponding to the candidate invariant. The anomaly score circuitry 604 may generate the subscore such that fewer anomalies result in a higher score, as anomaly detected can hint at a potential invariant violation. The example anomaly score circuitry 604 uses anomaly detection tools to monitor for breaches in invariants.

The example anomaly score circuitry 604 may use any number of factors to determine the anomaly subscore. Such factors include but are not limited to: Frequency of Anomalies (FoA), Severity of Anomalies (SoA), Recovery Rate (RR), and Predictive Accuracy (PA). As used above, FoA denotes the count of anomalies identified over a particular duration or set of tasks. A higher anomaly frequency typically leads to a lower ADS. The SoA is a value that accounts for anomalies that vary in impact. By classifying anomalies into categories such as minor, moderate, or major, a nuanced severity score can be assigned. The RR evaluates how effectively the model can rectify or counteract the consequences of the identified anomalies. Lastly, PA gauges the model's capability to forecast potential anomalies based on historical patterns and data.

An example calculation performed by the anomaly score circuitry 604 is as follows:

$$subscore \_ 604 = ϖ\_ 1 * ( 1 - FoA ) + ϖ\_ 2 * ( 1 - SoA ) + ϖ\_ 3 * RR + ϖ\_ 4 * PA$$

In the foregoing equation, [symbol] _1, [symbol] _2, [symbol] _3, and [symbol] _4 are weights for the respective factors, reflecting the factors' relative importance to the sub-score_604. Accordingly, the sum of the weights in the foregoing equation equals 1.

In some examples, an external device detects the anomalies that are used by the anomaly score circuitry 604 to form a subscore. In other examples, the anomaly score circuitry 604 detects the anomalies. The anomaly score circuitry 604 may use any number of suitable techniques to detect anomalies. Such techniques include but are not limited to Isolation Forest Machine Learning algorithms, One-class Support Vector Machine (SVM) algorithms, etc. In some examples, the anomaly score circuitry 604 embeds condition assertions directly into generated code and asks the LLM 309 to produce an output that includes the assertion. If the LLM 309 cannot include the condition assertion, an anomaly is detected.

The version stability score circuitry 606 generates a subscore based on the stability and reliability of different software versions within the proof context 306. The version stability subscore is designed to ensure that the candidate invariant would be maintained through different versions of code within the proof context 306. For example, if an update or a newer version of the proof context 306 violates any invariant, the version stability score circuitry 606 lowers the sub-score it produces. By tracking changes and improvements across versions of the proof context 306, the version stability score circuitry 606 can offer insights into the evolution of the LLM 309, helping stakeholders make informed decisions on updates and rollbacks.

The version stability score circuitry 606 may use any number of factors in producing a subscore. Such factors may include but are not limited to: Performance Consistency (PC), Bug Count and Severity (BCS), Rollback Frequency (RF), and Update Impact Analysis (UIA). As used above and herein, PC measures the variance in output quality across multiple versions. A stable program should exhibit minimal fluctuations in its performance metrics from one version to another, so variations in output would decrease the subscore. BCS tracks the number and gravity of reported issues in each version of the program. For example, the version stability score circuitry 606 may adjust the value of subscore in proportion to the severity of the bugs. RF indicates the number of times a version had to be reverted due to critical issues. Frequent rollbacks suggest instability, thereby prompting the version stability score circuitry 606 to reduce the subscore. Finally, UIA evaluates how well the program incorporates new updates. Such analysis involves assessing whether the latest updates lead to desired improvements without introducing significant new issues. Additionally, the version stability score circuitry 606 may decrease the subscore if changes to the proof context 306 lead to the counterexample circuitry creating less complete examples than before (as the less complete counterexamples are due to lower quality candidate invariants).

The benchmarking score circuitry 608 generates a subscore that compares the candidate invariant to established formal verification standards. The benchmarking score circuitry 608 may cause the benchmarking subscore to increase proportionally with the number of formal verification standards that the candidate invariant successfully adheres to. In some examples, the benchmarking score circuitry 608 uses data from the counterexample circuitry 316 (via the bus 312) to determine the candidate invariant has failed to meet a given verification standard. The benchmarking score circuitry 608 may additionally or alternatively use benchmarking data stored within the database 620 to determine the candidate invariant has failed to meet a given verification standard.

The user experience score circuitry 610 determines a subscore that quantifies the experience of users who interact with the program within the proof context 306 (e.g., users of the hardware devices 102). Such users may be unaware what an invariant is or why an invariant is significant to formal methods. Instead, the user experience score circuitry 610 generates a user experience subscore based on user interaction tracking and ease-of-use ratings. The user experience subscore is beneficial because the incorporation of invariant into a program may impact how a user experiences the program (e.g., response time, the ability to send data to input/output terminals, etc. may change due to the presence of an invariant).

The example expert feedback score circuitry 612 determines a subscore that quantifies feedback from subject matter experts. Such individuals may include but are not limited to computer scientists, mathematicians, engineers, etc. The expert feedback score circuitry 612 may produce an expert feedback subscore that reflects an average rating across multiple expert reviews.

The example control circuitry 614 the one or more subscores generated by the subscore circuitry 602 into a total score. To do so, the example control circuitry 614 first multiplies the one or more subscores by the weights 616. The weights 616 are values that add up to 1 and signify the relative importance of a given subscore. The example control circuitry 614 then produces a weighted sum (e.g., adds the products together) to form a total score. Such operations can be represented algebraically as:

$$total score = ϖ\_ 1 * ( AS ) + ϖ\_ 2 * ( VSS ) + ϖ\_ 3 * ( BS ) + ϖ\_ 4 * ( UES ) + ϖ\_ 5 * ( EFS ) .$$

In the foregoing equation, ( [symbol] _1, [symbol] _2, [symbol] _3, [symbol] _4, [symbol] _5) are the weights 616, AS is the Anomaly Subscore, VSS is the Version Stability Subscore, BS is the Benchmarking Subscore, UES is the User Experience Subscore, and EFS is the Expert Feedback Subscore. In some examples, the control circuitry 614 is instantiated by programmable circuitry executing control instructions and/or configured to perform operations such as those represented by the flowchart(s) of FIGS. 7-10. The control circuitry 614 may be implemented with any type of programmable circuitry.

The example feedback circuitry 618 makes changes to the value of the weights 616 based on user feedback. To determine when and how to change the weights 616, the feedback circuitry 618 may implement a neural network that uses reinforcement learning techniques. Such techniques may cause the feedback circuitry 618 to adjust the weights to maximize a reward (e.g., an objective function that describes user satisfaction). In some examples, the feedback circuitry 618 is instantiated by programmable circuitry executing feedback instructions and/or configured to perform operations such as those represented by the flowchart(s) of FIGS. 7-10.

The example control circuitry 614 compares the total score to a threshold value. If the total score does not exceed the threshold value, the control circuitry 614 may disregard the candidate invariant and instruct the input modification circuitry 318 (via the bus 312) to modify the model input provided to the LLM 309.

If the total score exceeds the threshold value, the candidate invariant is considered sufficiently reliable to justify further testing. In such examples, the control circuitry 614 may instruct the counterexample circuitry 316 (via the bus 312) to check the candidate invariant for counterexamples and/or instruct the proof test circuitry 320 (via the bus 312) to check if the candidate invariant discharges the proof obligation.

In some examples, the total score exceeding a threshold value causes the control circuitry 614 to permit the candidate invariant and/or the current values of the weights 616 to be stored in database 620. In the example of FIG. 6, the permission to store data in the database 620 is represented by the control circuitry 614 closing one or more switches.

The database 620 stores such high quality candidate invariants and corresponding weights so that other components of the score determination circuitry 314 can compare the data to future candidate invariants or future changes to the weights. In some examples, the database 620 also stores benchmarking data as described above. The database 620 is implemented by any memory, storage device and/or storage disc for storing data such as, for example, flash memory, magnetic media, optical media, solid state memory, hard drive(s), thumb drive(s), etc. Furthermore, the data stored in the database 620 may be in any data format such as, for example, binary data, comma delimited data, tab delimited data, structured query language (SQL) structures, etc. While, in the illustrated example, the database 620 is illustrated as a single device, the database 620 and/or any other data storage devices described herein may be implemented by any number and/or type(s) of memories.

While an example manner of implementing the example invariant generation circuitry 300 of FIG. 3 is illustrated in FIGS. 3-6, one or more of the elements, processes, and/or devices illustrated in FIGS. 3-6 may be combined, divided, re-arranged, omitted, eliminated, and/or implemented in any other way. Further, the example model trainer circuitry 308, the example model execution circuitry 310, the example bus 312, the example score determination circuitry 314, the example counterexample circuitry 316, the example input modification circuitry 318, the example proof test circuitry 320, and/or, more generally, the example invariant generation circuitry 300 of FIGS. 3-6, may be implemented by hardware alone or by hardware in combination with software and/or firmware. Thus, for example, any of the example model trainer circuitry 308, the example model execution circuitry 310, the example bus 312, the example score determination circuitry 314, the example counterexample circuitry 316, the example input modification circuitry 318, the example proof test circuitry 320, and/or, more generally, the example invariant generation circuitry 300 of FIGS. 3, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example invariant generation circuitry 300 of FIG. 3 may include one or more elements, processes, and/or devices in addition to, or instead of, those illustrated in FIG. 3, and/or may include more than one of any or all of the illustrated elements, processes and devices.

Flowchart(s) representative of example machine-readable instructions, which may be executed by programmable circuitry to implement and/or instantiate the invariant generation circuitry 300 of FIG. 3 and/or representative of example operations which may be performed by programmable circuitry to implement and/or instantiate the invariant generation circuitry 300 of FIG. 3, are shown in FIGS. 7-10. The machine-readable instructions may be one or more executable programs or portion(s) of one or more executable programs for execution by programmable circuitry such as the programmable circuitry 1112 shown in the example programmable circuitry platform 1100 discussed below in connection with FIG. 11 and/or may be one or more function(s) or portion(s) of functions to be performed by the example programmable circuitry (e.g., an FPGA) discussed below in connection with FIGS. 12 and/or 13. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 7-10, many other methods of implementing the example invariant generation circuitry 300 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 7-10 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

FIG. 7 is a flowchart representative of example machine-readable instructions and/or example operations 700 that may be executed, instantiated, and/or performed by programmable circuitry to train a model to synthesize invariants. The example machine-readable instructions and/or the example operations 700 of FIG. 7 begin when the input production circuitry obtains general training data. (Block 702). The general training data of block 702 may refer to the books 410, scientific articles 412, external code examples 414, and/or more generally, any source of information that provides code representations (some of which may have accompanying human language) and is generally available to the public.

The input production circuitry 302 adds context to the general training data. (Block 704). To add context, the input production circuitry 302 may generate augmented sub-expressions, produce pre- and post-expanded versions of code, provide graphs and/or textual descriptions of compiler passes, provide program tests, and/or provide proof data as described above in connection with FIG. 5.

The model production circuitry 402 trains a model based on the first training input. (Block 706). The model of block 706 is an initial LLM that has a broad understanding of various subjects, enabling it to grasp context, apply logic, and understand a multitude of programming and hardware description languages. The model production circuitry 402 may use any suitable technique to produce the initial LLM of block 706, including but not limited to Deep Learning.

The input production circuitry 302 obtains specific training data. (Block 708). Such specific training data includes but is not limited to RTL code 416 that has been collected over time, portions of other code bases 418, and formal verification examples 420. In some examples, the specific training data is provided by and/or corresponds to the same organization (e.g., a company) that provides a proof context 306 in need of invariants.

The input production circuitry 302 adds context to the specific training data. (Block 710). To add context, the input production circuitry 302 may generate augmented sub-expressions, produce pre- and post-expanded versions of code, provide graphs and/or textual descriptions of compiler passes, provide program tests, and/or provide proof data as described above in connection with FIG. 5. The specific training data and corresponding contextual data may be collectively referred to as an additional model input.

In some examples, the input production circuitry 302 is unable to identify or generate additional contextual data that corresponds to a given input. Such some examples may occur more with general training data than with specific training data because books 410 and scientific articles 412 generally have less contextual data available than code. In such examples, the input production circuitry 302 implements blocks 704 and 710 by adding contextual data, where available, based on the type of input.

The model tuner circuitry 404 tunes the model based on the additional model input. (Block 712). The model tuner circuitry 404 tunes the model by applying one or more subsequent rounds of training using the specific training data. The additional training enables the LLM 309 to produce candidate invariants based on a proof context 306. In some examples, the model training of block 706 is referred to as unsupervised learning while the model tuning of block 708 is referred to as supervised learning.

The verification circuitry 406 determines whether the model can be verified. (Block 714). The LLM 309 can be verified if the performance of the LLM 309 meets one or one or more threshold scores corresponding to accuracy, relevancy, and compliance with formal verification standards. The verification circuitry 406 measures the performance of LLM 309 by implementing the test cases 408.

If the LLM 309 cannot be verified (Block 714: No), control returns to block 708. In such examples, the model tuner circuitry 404 obtains an additional model input (if available) and performs a subsequent round of model training. The additional training improves one or more of the accuracy, relevancy, and/or compliance of the LLM 309.

If the LLM 309 can be verified (Block 714: Yes), the verification circuitry 406 permits the model to be used for execution. (Block 716). In the example of FIG. 4, the verification circuitry 406 by closing the switch 407, thereby allowing the model tuner circuitry 404 to provide the LLM 309 to the model execution circuitry 310. The example machine-readable instructions and/or the example operations 700 of FIG. 7 end after block 716.

FIG. 8 is a flowchart representative of example machine-readable instructions and/or example operations that may be executed, instantiated, and/or performed by example programmable circuitry to discharge a proof obligation as described in FIG. 3. The example machine-readable instructions and/or the example operations 800 of FIG. 8 begin when the input production circuitry 302 obtains a proof framework that requires an invariant. (Block 802). As described above, the proof context 306 refers to any sort of machine-readable instructions in need of formal methods 108 to prove the instructions are logically correct. The requirement to prove correctness may also be referred to as a proof obligation that must be discharged before the logic can proceed to the manufacturing processes 104.

The input production circuitry 302 adds context to the proof context 306 to produce a model input. (Block 804). To add context, the input production circuitry 302 may generate augment sub-expressions, produce pre- and post-expanded versions of code, provide graphs and/or textual descriptions of compiler passes, provide program tests, and/or provide proof data as described above in connection with FIG. 5.

The model execution circuitry 310 executes the model input with a verified model to synthesize an invariant. (Block 806). To produce the candidate invariant, the model execution circuitry 310 performs a sequence of operations using the LLM 309 and the model input to generate a textual output.

The score determination circuitry 314 scores the candidate invariant. (Block 808). The score determination circuitry 314 generates a score to quantify the quality of the candidate invariant. Block 808 is discussed further in connection with FIG. 9.

The score determination circuitry 314 determines whether the score exceeds a threshold. (Block 810). The threshold may be any value that describes a minimum quality acceptable for the candidate invariant to be incorporated into the proof context 306.

If the score does not exceed a threshold (Block 810: No), the input modification circuitry 318 modifies the model input. (Block 812). The input modification circuitry 318 may perform different types of input modifications based on factors that include but are not limited to the type of candidate invariant, data within the proof context 306, a score of the candidate invariant, the presence of counterexamples to the candidate invariant, etc. Control returns to block 806 after block 812 so that a new candidate invariant can be produced using the modified model input. Block 812 is discussed further in connection with FIG. 10.

If the score does exceed a threshold (Block 810: Yes), the counterexample circuitry 316 determines if a counterexample to the candidate invariant can be found. (Block 814). The counterexample circuitry 316 may use any suitable technique to check for counterexamples. Such techniques include but are not limited to symbolic algorithms, bounded model-checking, abstraction, Counterexample-guided abstraction refinement (CEGAR), etc.

If a counterexample to the candidate invariant is found (Block 814: Yes), then the assertion posited by the candidate invariant is not always correct (thus making the candidate invariant invalid and not usable in the proof context 306). In such examples, control returns to block 812 where the input modification circuitry 318 modifies the model input.

If a counterexample to the candidate invariant is not found (Block 814: No), the proof test circuitry 320 determines whether the proof obligation of the proof context 306 can be discharged. (Block 816). The proof test circuitry 320 determines whether the candidate invariant discharges the proof obligation by analyzing the proof obligation as a set of subgoals within a tree data structure as described above. If the proof obligation can be discharged (Block 816: Yes), then the proof context 306 has been verified as ready for the manufacturing processes 104. Accordingly, the example machine-readable instructions and/or the example operations 800 end if the proof obligation is discharged.

If the proof obligation cannot be discharged (Block 816: No), the proof test circuitry 320 optionally discharges subgoals. (Block 818). In some examples, a candidate invariant is unable to prove all of the sub-goals that collectively form a proof obligation but can still satisfy some subset of the sub-goals that need to be proved. In such examples, the candidate invariant may be considered a useful invariant and incorporated into the proof context 306 because it aids in the completion of the proof obligation. Therefore, the example proof test circuitry 320 may discharge any subgoals that are proved by the invariant so that the invariant generation circuitry 300 and/or human developers of the proof context 306 have an accurate understanding of which subgoals are left to prove.

In some examples, the proof test circuitry 320 determines a candidate invariant can logically complete a subgoal but still does not discharge the subgoal at block 818. In such examples, the proof test circuitry 320 keeps the subgoal as active within the proof obligation in response to a decision to not incorporate the candidate invariant into the proof context 306. Such a decision may occur for any reason. For example, if the score determination circuitry 314 produces a score in a range that indicates the quality of the candidate invariant is “good but not great”, the proof test circuitry 320 may keep the subgoal as active in anticipation that a subsequent iteration of blocks 804-816 will produce another candidate invariant with a better subscore.

After optionally discharging proof subgoals, the example proof test circuitry 320 determines whether to generate another candidate invariant (Block 820). In some examples, the proof test circuitry 320 determines that generating an additional candidate invariant would be helpful in discharging the proof obligation. In such examples (Block 820: Yes), control returns to block 820. Accordingly, the input modification circuitry 318 modifies the model input and the model execution circuitry 310 generates a new candidate invariant at block 806.

In other examples, the proof test circuitry 320 decides not to generate another candidate invariant. (Block 820: No). The example proof test circuitry 320 may decide to stop generating candidate invariants for any reason. For example, the proof test circuitry 320 may be configured to stop the generation of additional invariants if a threshold number of consecutive candidate invariants have failed to satisfy any of the remaining subgoals of the proof obligation. Such failure may occur for any number of reasons, including but not limited to due to the complexity and/or type of logic within the proof context 306, computational resource restraints, lack of sufficient training input or model input data, etc.

If the proof test circuitry 320 decides not to generate another candidate invariant (Block 820: No), the proof test circuitry 320 prompts a human to write a remaining invariant. (Block 822). In such examples, manual invariant synthesis by a human is used to discharge the proof obligation and complete the verification of the proof context 306. Advantageously, the invariant generation circuitry 300 reduces the amount of manual work required by a human at block 822. The reduction of work occurs because the invariant generation circuitry 300 does automatically synthesize some candidate invariants and discharge some subgoals that would otherwise require human input to complete. The example machine-readable instructions and/or the example operations 800 end after block 822.

The flowchart of FIG. 8 is one example implementation of how components within the invariant generation circuitry 300 interact with one another to synthesize and analyze candidate invariants. In other examples, the invariant generation circuitry 300 may proceed directly to block 822 after an amount of consecutive candidate invariants fail to exceed a threshold score at block 810. In still other examples, a score does not exceed the threshold of block 810, but the candidate invariant is still checked by the counterexample circuitry 316 and used by the proof test circuitry 320 to discharge at least one sub-goal of the proof obligation. Accordingly, the invariant generation circuitry 300 can be configured to alter the balance between further attempts to discharge the proof obligation and the use of computational resources.

FIG. 9 is a flowchart representative of example machine-readable instructions and/or example operations that may be executed, instantiated, and/or performed by example programmable circuitry to score a candidate invariant as described in FIG. 8. In particular, the flowchart of FIG. 9 is an example implementation of block 808 of FIG. 8.

The execution of block 808 begins when the example anomaly score circuitry 604 optionally computes an anomaly subscore (Block 902). The anomaly score circuitry 604 may determine the anomaly subscore using any number of techniques as described above in connection with FIG. 6. In some examples, the anomaly subscore is proportional to a number of detected anomalies and/or indicates a potential invariant violation.

The example version stability score circuitry 606 optionally computes the Version Stability Subscore (Block 904). The Version Stability Subscore describes the ability of the candidate invariant to remain logically correct throughout different versions of the proof context 306. The example version stability score circuitry 606 computes the Version Stability Subscore using factors including but not limited to Performance Consistency (PC), Bug Count and Severity (BCS), Rollback Frequency (RF), and Update Impact Analysis (UIA) as described above in connection with FIG. 6.

The example benchmarking score circuitry 608 optionally computes the Benchmarking Subscore (Block 906). The Benchmarking Subscore compares the candidate invariant to established formal verification standards as described above in connection with FIG. 6.

The example user experience score circuitry 610 optionally computes the User Experience Subscore (Block 908). The User Experience Subscore is based on user interaction tracking and ease-of-use ratings from humans that use the proof context 306 program as described above in connection with FIG. 6.

The example expert feedback score circuitry 612 optionally computes the Expert Feedback Subscore (Block 910). The Expert Feedback Subscore averages ratings from any number of experts familiar with invariants, formal methods, and/or logic verification as described above in connection with FIG. 6.

The example control circuitry 614 applies weights to the one or more subscores that were computed at blocks 902-910. (Block 912). The weights refer to values that signify the relative significance of the subscores. In some examples, the score determination circuitry 314 applies the weights by multiplying a given weight value with the corresponding subscore.

The example control circuitry 614 provides a total score. (Block 914). In some examples, the score determination circuitry 314 produces a total score by adding the products of the weights and subscores together. In other examples, the score determination circuitry 314 by averaging the products of the weights and subscores. The example control circuitry 614 may provide the total score to the counterexample circuitry 316, the proof test circuitry 320, and/or the input modification circuitry 318 depending on the value of the total score.

The example feedback circuitry 618 determines if any feedback has been received. (Block 916). If feedback has been received (Block 916: Yes), the feedback circuitry 618 adjusts the weights based on the feedback. The feedback circuitry 618 may use any suitable technique to adjust the weights, including but not limited to reinforcement learning. After block 918, or if feedback has not been received (Block 916: No), the machine-readable instructions and/or the example operations 800 return to block 810.

FIG. 10 is a flowchart representative of example machine-readable instructions and/or example operations that may be executed, instantiated, and/or performed by example programmable circuitry to modify a model input and/or training input as described in FIG. 8. In particular, the flowchart of FIG. 10 is an example implementation of block 812 of FIG. 8.

Execution of block 812 begins when the input modification circuitry 318 optionally performs a syntactic transformation of code within the model input. (Block 1002). Such operations change the format of the model input without changing the substance (e.g., the underlying information), which may cause the LLM 309 to produce a different (and possibly improved) output. Examples of operations performed by the input modification circuitry 318 at block 1002 include but are not limited to: renaming tokens such as variable names, adding idempotent operations (e.g., “x:=x”), or re-ordering statements that do not depend on one another (e.g., swapping the statements “x:=y” and “a:=b”).

The input modification circuitry 318 optionally adds a textual representation of a counterexample to the model input. (Block 1004). For example, in FIG. 2, suppose that the LLM 309 had initially generated an invariant with the incorrect expression ‘high>a.Length’ at line 3 of code snippet 200. Suppose further that the example counterexample circuitry 316 found a counterexample where ‘high=4’ and ‘a.Length=8’. In such an example, the input modification circuitry 318 may modify the model input to include a statement that reads: “synthesize an invariant such that a.Length cannot be greater than high.”

The input modification circuitry 318 optionally prompts the model for inline comments describing code behavior. (Block 1006). In general, the accuracy of an LLM that is designed to process source code improves when the LLM is provided with code that includes comments. Accordingly, if portions of the code within the proof context 306 have no or relatively new comments, the input modification circuitry 318 may first prompt the model execution circuitry 310 to use the LLM 309 to produce an output that merely adds comments to the relevant section of code. The input modification circuitry 318 may then use the resulting model output as part of a modified model input. Notably, the rest of the code from the proof context 306, corresponding contextual data, etc., may also be included in the modified model input. The example input modification circuitry 318 would then prompt the model execution circuitry 310 to use the LLM 309 to synthesize a candidate invariant based on the modified model input as described above.

The input modification circuitry 318 optionally converts a counterexample into a formula. (Block 1008). For example, suppose the counterexample circuitry 316 generates a counterexample where variable x has been assigned the value 3 and variable y has been assigned the value 4. In such examples, input modification circuitry 318 may perform operations at block 1008 that translate the counterexample into the formula (x==3 && y==4). The example input modification circuitry 318 then modifies the model input to include the formula.

The input modification circuitry 318 optionally uses a counterexample for Few-Shot Learning (FSL). (Block 1010). In general, FSL refers to a Machine Learning technique that enables a pre-trained model (e.g., the LLM 309) to generalize over new (e.g., not used before in training) categories of data using a relatively small number of labeled samples per class. Accordingly, by adding the counterexample into a modified training input, the input modification circuitry 318 can cause the model trainer circuitry 308 to generate a new version of the LLM 309 that has a better understanding of what not to generate.

The input modification circuitry 318 optionally removes input components unrelated to a counterexample. (Block 1012). For example, the input modification circuitry 318 may analyze the sequence of counterexamples found so far to determine which variables and/or state elements of code in the model input the counterexamples depend on. Parts of the original model input that do not contribute to those variables or state elements can be removed or perturbed more aggressively by the input modification circuitry 318. The input modification circuitry 318 may identify such parts of the original model input using static or dynamic program analysis algorithms.

The input modification circuitry 318 optionally provides model metadata for training. (Block 1014). Some satisfiability solver programs that can be used to implement the proof test circuitry 320 (e.g., theorem prover programs, Satisfiability modulo theories (SMT) solver programs, Boolean satisfiability (B-SAT) solver programs, etc.) provide metadata that corresponds to a given query. This metadata may contain, for example, statistics about the query, such as the total elapsed time, total (or peak) memory usage, number of formal model parameters, etc.

In other invariant synthesis systems, metadata from satisfiability solver programs can help a proof engineer to understand when a change to a model has inadvertently caused a large increase in the state or search space. Such an increase of search space in other invariant synthesis systems is generally indicative that a proof engineer needs to manually refine the model, the assertion, or the invariant being checked. Within the example invariant generation circuitry 300 described herein, the input modification circuitry 318 may use the metadata to augment the loss function used to train the LLM 309, and consequently, penalize future versions of the LLM 309 for generating invariants that stress the proof tester circuitry 320.

The example input modification circuitry 318 determines one or more of blocks 1002-1014 to execute based on the information available when the example machine-readable instructions and/or the example operations 800 implements block 812. For example, if a modification is requested before the counterexample circuitry checks for counterexamples (e.g., at Block 810: No of FIG. 8), the input modification circuitry 318 may be unable to execute blocks 1004-1012. Similarly, the input modification circuitry 318 may execute block 1014 in situations where the proof test circuitry 320 has already checked if the candidate invariant can be discarded (e.g., at Block 820: Yes of FIG. 8). In doing so, the example input modification circuitry 318 attempts to improve the model training and/or execution using whatever additional data has been generated by the invariant generation circuitry 300 since the last input modification.

FIG. 11 is a block diagram of an example programmable circuitry platform 1100 structured to execute and/or instantiate the example machine-readable instructions and/or the example operations of FIGS. 7-10 to implement the invariant generation circuitry 300 of FIG. 3. The programmable circuitry platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, and/or microcontrollers from any desired family or manufacturer. The programmable circuitry 1112 may be implemented by one or more semiconductor based (e.g., silicon based) devices. In this example, the programmable circuitry 1112 implements the example input production circuitry 302, the example model trainer circuitry 308, the example LLM 309, the example model execution circuitry 310, the example score determination circuitry 314, the example counterexample circuitry 316, the example input modification circuitry 318, and the example proof test circuitry 320.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116. In this example, the main memory 1114, 1116 implements the example training corpus 304 and the example proof context 306.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1132, which may be implemented by the machine-readable instructions of FIGS. 7-10, may be stored in the mass storage device 1128, in the volatile memory 1114, in the non-volatile memory 1116, and/or on at least one non-transitory computer readable storage medium such as a CD or DVD which may be removable.

FIG. 12 is a block diagram of an example implementation of the programmable circuitry 1112 of FIG. 11. In this example, the programmable circuitry 1112 of FIG. 11 is implemented by a microprocessor 1200. For example, the microprocessor 1200 may be a general-purpose microprocessor (e.g., general-purpose microprocessor circuitry). The microprocessor 1200 executes some or all of the machine-readable instructions of the flowcharts of FIGS. 7-10 to effectively instantiate the circuitry of FIG. 2 as logic circuits to perform operations corresponding to those machine-readable instructions. In some such examples, the circuitry of FIG. 3 is instantiated by the hardware circuits of the microprocessor 1200 in combination with the machine-readable instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine-readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine-readable instructions and/or operations represented by the flowcharts of FIGS. 7-10.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer-based operations. In other examples, the AL circuitry 1216 also performs floating-point operations. In yet other examples, the AL circuitry 1216 may include first AL circuitry that performs integer-based operations and second AL circuitry that performs floating-point operations. In some examples, the AL circuitry 1216 may be referred to as an Arithmetic Logic Unit (ALU).

The registers 1218 are semiconductor-based structures to store data and/or instructions such as results of one or more of the operations performed by the AL circuitry 1216 of the corresponding core 1202. For example, the registers 1218 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure, such as by being distributed throughout the core 1202 to shorten access time. The second bus 1222 may be implemented by at least one of an I2C bus, a SPI bus, a PCI bus, or a PCle bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages.

The microprocessor 1200 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1200, in the same chip package as the microprocessor 1200 and/or in one or more separate packages from the microprocessor 1200.

FIG. 13 is a block diagram of another example implementation of the programmable circuitry 1112 of FIG. 11. In this example, the programmable circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine-readable instructions. However, once configured, the FPGA circuitry 1300 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1200 of FIG. 12 described above (which is a general purpose device that may be programmed to execute some or all of the machine-readable instructions represented by the flowchart(s) of FIGS. 7-10 but whose interconnections and logic circuitry are fixed once fabricated), the FPGA circuitry 1300 of the example of FIG. 13 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 7-10. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 7-10. As such, the FPGA circuitry 1300 may be configured and/or structured to effectively instantiate some or all of the operations/functions corresponding to the machine-readable instructions of the flowchart(s) of FIGS. 7-10 as dedicated logic circuits to perform the operations/functions corresponding to those software instructions in a dedicated manner analogous to an ASIC. Therefore, the FPGA circuitry 1300 may perform the operations/functions corresponding to the some or all of the machine-readable instructions of FIGS. 7-10 faster than the general-purpose microprocessor can execute the same.

In the example of FIG. 13, the FPGA circuitry 1300 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain a binary file, which may be implemented by a bit stream, data, and/or machine-readable instructions, to configure the FPGA circuitry 1300, or portion(s) thereof. In some such examples, the configuration circuitry 1304 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1306 may be implemented by external hardware circuitry. For example, the external hardware 1306 may be implemented by the microprocessor 1200 of FIG. 12.

The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations/functions that may correspond to at least some of the machine-readable instructions of FIGS. 7-10 and/or other desired operations. The logic gate circuitry 1308 shown in FIG. 13 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations/functions. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example dedicated operations circuitry 1314. In this example, the dedicated operations circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the programmable circuitry 1112 of FIG. 11, many other approaches are contemplated. For example, FPGA circuitry may include an on-board CPU, such as one or more of the example CPU 1320 of FIG. 12. Therefore, the programmable circuitry 1112 of FIG. 11 may additionally be implemented by combining at least the example microprocessor 1200 of FIG. 12 and the example FPGA circuitry 1300 of FIG. 13. In some such hybrid examples, one or more cores 1202 of FIG. 12 may execute a first portion of the machine-readable instructions represented by the flowchart(s) of FIGS. 7-10 to perform first operation(s)/function(s), the FPGA circuitry 1300 of FIG. 13 may be configured and/or structured to perform second operation(s)/function(s) corresponding to a second portion of the machine-readable instructions represented by the flowcharts of FIGS. 7-10, and/or an ASIC may be configured and/or structured to perform third operation(s)/function(s) corresponding to a third portion of the machine-readable instructions represented by the flowcharts of FIGS. 7-10.

It should be understood that some or all of the circuitry of FIG. 3 may, thus, be instantiated at the same or different times. For example, same and/or different portion(s) of the microprocessor 1200 of FIG. 12 may be programmed to execute portion(s) of machine-readable instructions at the same and/or different times. In some examples, same and/or different portion(s) of the FPGA circuitry 1300 of FIG. 13 may be configured and/or structured to perform operations/functions corresponding to portion(s) of machine-readable instructions at the same and/or different times.

In some examples, some or all of the circuitry of FIG. 3 may be instantiated, for example, in one or more threads executing concurrently and/or in series. For example, the microprocessor 1200 of FIG. 12 may execute machine-readable instructions in one or more threads executing concurrently and/or in series. In some examples, the FPGA circuitry 1300 of FIG. 13 may be configured and/or structured to carry out operations/functions concurrently and/or in series. Moreover, in some examples, some or all of the circuitry of FIG. 3 may be implemented within one or more virtual machines and/or containers executing on the microprocessor 1200 of FIG. 12.

In some examples, the programmable circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the programmable circuitry 1112 of FIG. 11, which may be in one or more packages. For example, the XPU may include a CPU (e.g., the microprocessor 1200 of FIG. 12, the CPU 1320 of FIG. 13, etc.) in one package, a DSP (e.g., the DSP 1322 of FIG. 13) in another package, a GPU in yet another package, and an FPGA (e.g., the FPGA circuitry 1300 of FIG. 13) in still yet another package.

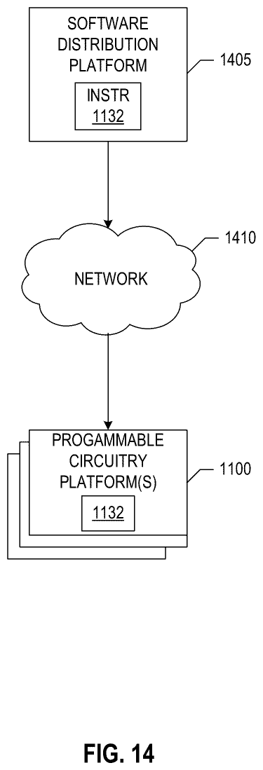

A block diagram illustrating an example software distribution platform 1405 to distribute software such as the example machine-readable instructions 1132 of FIG. 11 to other hardware devices (e.g., hardware devices owned and/or operated by third parties from the owner and/or operator of the software distribution platform) is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine-readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine-readable instructions 1132, which may correspond to the example machine-readable instructions of FIGS. 7-10, as described above. The one or more servers of the example software distribution platform 1405 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1132 from the software distribution platform 1405. For example, the software, which may correspond to the example machine-readable instructions of FIGS. 7-10, may be downloaded to the example programmable circuitry platform 1100, which is to execute the machine-readable instructions 1132 to implement the invariant generation circuitry 300. In some examples, one or more servers of the software distribution platform 1405 periodically offer, transmit, and/or force updates to the software (e.g., the example machine-readable instructions 1132 of FIG. 11) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real-world imperfections as will be understood by persons of ordinary skill in the art. For example, “approximately” and “about” may indicate such dimensions may be within a tolerance range of +/−10% unless otherwise specified herein.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that automate the synthesis of invariants. Disclosed systems, apparatus, articles of manufacture, and methods improve the efficiency of using a computing device by performing operations that include adding contextual data to a variety of data sources to produce both training inputs model inputs, and training a LLM based on the training inputs. The operations performed according to examples described herein further include executing the LLM on a proof framework and corresponding contextual data to generate a candidate invariant, generating a total score for the candidate invariant based on one or more weighted subscores, and checking for counterexamples to the candidate invariant. The operations performed according to examples described herein further include checking if the candidate invariant discharges the proof obligation, modifying the training input when appropriate, and modifying the model input when appropriate. As a result, the examples disclosed herein can generate a greater number of invariants and a wider variety of invariant types (e.g., invariants that correspond to conditions within code) than legacy invariant synthesis techniques. Disclosed systems, apparatus, articles of manufacture, and methods are accordingly directed to one or more improvement(s) in the operation of a machine such as a computer or other electronic and/or mechanical device. Examples disclosed herein are directed to real world improvements in manufacturing reliable electronics and/or other devices.

Example methods, apparatus, systems, and articles of manufacture to automate invariant synthesis are disclosed herein. Further examples and combinations thereof include the following.

Example 1 includes an apparatus to automate invariant synthesis, the apparatus comprising interface circuitry, instructions, and at least one programmable circuit to be programmed by the instructions to produce a model input based on a program and/or contextual data corresponding to the program, provide the model input to a Large Language Model (LLM), the LLM to produce an invariant based on the model input, score the invariant, and incorporate the invariant into the program based on the score.

Example 2 includes the apparatus of example 1, wherein one or more of the at least one programmable circuit is to train the LLM using a corpus of programs and contextual data corresponding to the programs.

Example 3 includes the apparatus of one or more of examples 1 or 2, wherein the score is a total score, and one or more of the at least one programmable circuit is to produce the total score based on one or more of an anomaly subscore, a version stability subscore, a benchmarking subscore, a user experience subscore, or an expert feedback subscore.

Example 4 includes the apparatus of one or more of examples 1-3, wherein one or more of the at least one programmable circuit is to produce the total score by assigning weights to the one or more of the anomaly subscore, the version stability subscore, the benchmarking subscore, the user experience subscore, or the expert feedback subscore, and computing a weighted sum based on the weights.

Example 5 includes the apparatus of one or more of examples 1-4, wherein one or more of the at least one programmable circuit is to adjust the weights based on user feedback.

Example 6 includes the apparatus of one or more of examples 1-5, wherein one or more of the at least one programmable circuit is to implement reinforcement learning to adjust the weights.

Example 7 includes the apparatus of one or more of examples 1-6, wherein one or more of the at least one programmable circuit is to perform a check for counterexamples to the invariant.

Example 8 includes the apparatus of one or more of examples 1-7, wherein one or more of the at least one programmable circuit is to incorporate the invariant based on the check failing to produce a counterexample to the invariant.

Example 9 includes the apparatus of one or more of examples 1-8, wherein the invariant is a first invariant, and one or more of the at least one programmable circuit is to discard the first invariant, modify the model input, and provide the modified model input to the LLM, the LLM to produce a second invariant based on the modified model input.

Example 10 includes the apparatus of one or more of examples 1-9, wherein one or more of the at least one programmable circuit is to modify the model input in response to a determination that the score of the first invariant satisfies a threshold.

Example 11 includes the apparatus of one or more of examples 1-10, wherein one or more of the at least one programmable circuit is to modify the model input in response to identifying a counterexample to the first invariant.

Example 12 includes an apparatus to automate invariant synthesis, the apparatus comprising interface circuitry, instructions, and at least one programmable circuit to be programmed by the instructions to train, using first training data, a Large Language Model (LLM), train, using second training data, the LLM to produce invariants, and verify that the LLM can produce an invariant that is usable within an input program, the invariant corresponding to a conditional statement within the input program.

Example 13 includes the apparatus of example 12, wherein the second training data includes an example of an invariant and a corresponding program.

Example 14 includes the apparatus of one or more of examples 12-13, wherein one or more of the at least one programmable circuit is to generate contextual data corresponding to the second training data, and train the LLM to produce invariants using the second training data and the contextual data.

Example 15 includes the apparatus of one or more of examples 12-14, wherein to generate the contextual data one or more of the at least one programmable circuit is to perform one or more of augment sub-expressions of code within the second training data, generate pre-expansion and post-expansion versions of code within the second training data, generate a parse tree or a textual description based on compiler passes of code within the second training data, identify unit tests that correspond to code within the second training data, or identify proofs that correspond to code within the second training data.

Example 16 includes the apparatus of one or more of examples 12-15, wherein to verify that the LLM can produce an invariant that is usable within an input program, one or more of the at least one programmable circuit is to execute a test case, and determine, based on the test case accuracy of the LLM, relevance of the LLM, and compliance of the LLM with verification standards.

Example 17 includes the apparatus of one or more of examples 12-16, wherein one or more of the at least one programmable circuit is to modify the second training data, and train a new version of the LLM based on the modified second training data.

Example 18 includes the apparatus of one or more of examples 12-17, wherein one or more of the at least one programmable circuit is to modify the second training data in response to a determination that a score of an invariant produced by the LLM satisfies a threshold.

Example 19 includes the apparatus of one or more of examples 12-18, wherein one or more of the at least one programmable circuit is to modify the second training data in response to an identification of a counterexample to an invariant produced by the LLM.

Example 20 includes the apparatus of one or more of examples 12-19, wherein one or more of the at least one programmable circuit is to modify the second training data by adding a description of the counterexample.

Example 21 includes the apparatus of one or more of examples 12-20, wherein one or more of the at least one programmable circuit is to modify the second training data to include a syntactic transformation of code within the second training data.

Example 22 includes the apparatus of one or more of examples 12-21, wherein one or more of the at least one programmable circuit is to modify the second training data by providing metadata produced by a satisfiability solver program.

Example 23 includes a non-transitory machine-readable storage medium comprising instructions to cause at least one programmable circuit to at least produce a model input based on a program and/or contextual data corresponding to the program, provide the model input to a Large Language Model (LLM), the LLM to produce an invariant based on the model input, score the invariant, and incorporate the invariant into the program based on the score.

Example 24 includes the non-transitory machine-readable storage medium of example 23, wherein the instructions cause one or more of the at least one programmable circuit to train the LLM using a corpus of programs and contextual data corresponding to the programs.

Example 25 includes the non-transitory machine-readable storage medium of one or more of examples 23-24, wherein the score is a total score, and the one or more of the at least one programmable circuit to produce the total score based on one or more of an anomaly subscore, a version stability subscore, a benchmarking subscore, a user experience subscore, or an expert feedback subscore.

Example 26 includes the non-transitory machine-readable storage medium of one or more of examples 23-25, wherein the instructions cause one or more of the at least one programmable circuit to produce the total score by assigning weights to the one or more of the anomaly subscore, the version stability subscore, the benchmarking subscore, the user experience subscore, or the expert feedback subscore, and computing a weighted sum based on the weights.

Example 27 includes the non-transitory machine-readable storage medium of one or more of examples 23-26, wherein the instructions cause one or more of the at least one programmable circuit to adjust the weights based on user feedback.

Example 28 includes the non-transitory machine-readable storage medium of one or more of examples 23-27, wherein the instructions cause one or more of the at least one programmable circuit to implement reinforcement learning to adjust the weights.

Example 29 includes the non-transitory machine-readable storage medium of one or more of examples 23-29, wherein the instructions cause one or more of the at least one programmable circuit to perform a check for counterexamples to the invariant.

Example 30 includes the non-transitory machine-readable storage medium of one or more of examples 23-29, wherein the instructions cause one or more of the at least one programmable circuit to incorporate the invariant based on the check failing to produce a counterexample to the invariant.

Example 31 includes the non-transitory machine-readable storage medium of one or more of examples 23-30, wherein the invariant is a first invariant, and the instructions cause one or more of the at least one programmable circuit to discard the first invariant, modify the model input, and provide the modified model input to the LLM, the LLM to produce a second invariant based on the modified model input.

Example 32 includes the non-transitory machine-readable storage medium of one or more of examples 23-31, wherein the instructions cause one or more of the at least one programmable circuit to modify the model input in response to a determination that the score of the first invariant satisfies a threshold.

Example 33 includes the non-transitory machine-readable storage medium of one or more of examples 23-32, wherein the instructions cause one or more of the at least one programmable circuit to modify the model input in response to identifying a counterexample to the first invariant.

Example 34 includes a non-transitory machine-readable storage medium comprising instructions to cause at least one programmable circuit to at least train, using first training data, a Large Language Model (LLM), train, using second training data, the LLM to produce invariants, and verify that the LLM can produce an invariant that is usable within an input program, the invariant corresponding to a conditional statement within the input program.

Example 35 includes the non-transitory machine-readable storage medium of example 34, wherein the second training data includes an example of an invariant and a corresponding program.

Example 36 includes the non-transitory machine-readable storage medium of one or more of examples 34-35, wherein the instructions cause one or more of the at least one programmable circuit to generate contextual data corresponding to the second training data, and train the LLM to produce invariants using the second training data and the contextual data.

Example 37 includes the non-transitory machine-readable storage medium of one or more of examples 34-36, wherein to generate the contextual data, the instructions cause one or more of the at least one programmable circuit to perform one or more of augment sub-expressions of code within the second training data, generate pre-expansion and post-expansion versions of code within the second training data, generate a parse tree or a textual description based on compiler passes of code within the second training data, identify unit tests that correspond to code within the second training data, or identify proofs that correspond to code within the second training data.

Example 38 includes the non-transitory machine-readable storage medium of one or more of examples 34-37, wherein to verify that the LLM can produce an invariant that is usable within an input program, the instructions cause one or more of the at least one programmable circuit to execute a test case, and determine, based on the test case accuracy of the LLM, relevance of the LLM, and compliance of the LLM with verification standards.

Example 39 includes the non-transitory machine-readable storage medium of one or more of examples 34-38, wherein the instructions cause one or more of the at least one programmable circuit to modify the second training data, and train a new version of the LLM based on the modified second training data.

Example 40 includes the non-transitory machine-readable storage medium of one or more of examples 34-39, wherein the instructions cause one or more of the at least one programmable circuit to modify the second training data in response to a determination that a score of an invariant produced by the LLM satisfies a threshold.

Example 41 includes the non-transitory machine-readable storage medium of one or more of examples 34-40, wherein the instructions cause one or more of the at least one programmable circuit is to modify the second training data in response to an identification of a counterexample to an invariant produced by the LLM.

Example 42 includes the non-transitory machine-readable storage medium of one or more of examples 34-41, wherein the instructions cause one or more of the at least one programmable circuit to modify the second training data by adding a description of the counterexample.

Example 43 includes the non-transitory machine-readable storage medium of one or more of examples 34-42, wherein the instructions cause one or more of the at least one programmable circuit to modify the second training data to include a syntactic transformation of code within the second training data.

Example 44 includes the non-transitory machine-readable storage medium of one or more of examples 34-43, wherein the instructions cause the one or more of the at least one programmable circuit to modify the second training data by providing metadata produced by a satisfiability solver program.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to automate invariant synthesis, the apparatus comprising:
interface circuitry;
instructions; and
at least one programmable circuit to be programmed by the instructions to:
produce a model input based on a program and/or contextual data corresponding to the program;
provide the model input to a Large Language Model (LLM), the LLM to produce an invariant based on the model input;
score the invariant; and
incorporate the invariant into the program based on the score.

2. The apparatus of claim 1, wherein one or more of the at least one programmable circuit is to train the LLM using a corpus of programs and contextual data corresponding to the programs.

3. The apparatus of claim 1, wherein:
the score is a total score; and
one or more of the at least one programmable circuit is to produce the total score based on one or more of:
an anomaly subscore;
a version stability subscore;
a benchmarking subscore;
a user experience subscore; or
an expert feedback subscore.

4. The apparatus of claim 3, wherein one or more of the at least one programmable circuit is to produce the total score by:
assigning weights to the one or more of:
the anomaly subscore;
the version stability subscore;
the benchmarking subscore;
the user experience subscore; or
the expert feedback subscore; and
computing a weighted sum based on the weights.

5. The apparatus of claim 4, wherein one or more of the at least one programmable circuit is to adjust the weights based on user feedback.

6. The apparatus of claim 5, wherein one or more of the at least one programmable circuit is to implement reinforcement learning to adjust the weights.

7. The apparatus of claim 1, wherein one or more of the at least one programmable circuit is to incorporate the invariant based on a check failing to produce a counterexample to the invariant.

8. The apparatus of claim 1, wherein:
the invariant is a first invariant; and
one or more of the at least one programmable circuit is to:
discard the first invariant;
modify the model input; and
provide the modified model input to the LLM, the LLM to produce a second invariant based on the modified model input.

9. The apparatus of claim 8, wherein one or more of the at least one programmable circuit is to modify the model input in response to identifying a counterexample to the first invariant.

10. An apparatus to automate invariant synthesis, the apparatus comprising:
interface circuitry;
instructions; and
at least one programmable circuit to be programmed by the instructions to:
train, using first training data, a Large Language Model (LLM);
train, using second training data, the LLM to produce invariants; and
verify that the LLM can produce an invariant that is usable within an input program, the invariant corresponding to a conditional statement within the input program.

11. The apparatus of claim 10, wherein the second training data includes an example of an invariant and a corresponding program.

12. The apparatus of claim 10, wherein one or more of the at least one programmable circuit is to:
generate contextual data corresponding to the second training data; and
train the LLM to produce invariants using the second training data and the contextual data.

13. The apparatus of claim 12, wherein to generate the contextual data one or more of the at least one programmable circuit is to perform one or more of:
augment sub-expressions of code within the second training data;
generate pre-expansion and post-expansion versions of code within the second training data;
generate a parse tree or a textual description based on compiler passes of code within the second training data;
identify unit tests that correspond to code within the second training data; or
identify proofs that correspond to code within the second training data.

14. The apparatus of claim 10, wherein to verify that the LLM can produce an invariant that is usable within an input program, one or more of the at least one programmable circuit is to:
execute a test case; and
determine, based on the test case:
accuracy of the LLM;
relevance of the LLM; and
compliance of the LLM with verification standards.

15. The apparatus of claim 10, wherein one or more of the at least one programmable circuit is to:
modify the second training data; and
train a new version of the LLM based on the modified second training data.

16. The apparatus of claim 15, wherein one or more of the at least one programmable circuit is to modify the second training data in response to a determination that a score of an invariant produced by the LLM satisfies a threshold.

17. The apparatus of claim 15, wherein one or more of the at least one programmable circuit is to modify the second training data in response to an identification of a counterexample to an invariant produced by the LLM.

18. A non-transitory machine-readable storage medium comprising instructions to cause at least one programmable circuit to at least:
produce a model input based on a program and/or contextual data corresponding to the program;
provide the model input to a Large Language Model (LLM), the LLM to produce an invariant based on the model input;
score the invariant; and
incorporate the invariant into the program based on the score.

19. The non-transitory machine-readable storage medium of claim 18, wherein the instructions cause one or more of the at least one programmable circuit to train the LLM using a corpus of programs and contextual data corresponding to the programs.

20. The non-transitory machine-readable storage medium of claim 18, wherein:
the score is a total score; and
the one or more of the at least one programmable circuit to produce the total score based on one or more of:
an anomaly subscore;
a version stability subscore;
a benchmarking subscore;
a user experience subscore; or
an expert feedback subscore.
